(19) United States
(12) Patent Application Publication
(10) Pub. No.: US 2026/0002371 A1
(43) Pub. Date: Jan. 1, 2026

(54) CONSTRUCTION MATERIAL DELIVERY

(71) Applicant: FASTBRICK IP PTY LTD, High Wycombe (AU)

(72) Inventor: Mark Joseph Pivac, High Wycombe (AU)

(21) Appl. No.: 18/878,379

(22) PCT Filed: Jun. 29, 2023
(86) PCT No.: PCT/AU2023/050600

§ 371 Date: Dec. 23, 2024

(30) Foreign Application Priority Data
Jun. 30, 2022 (AU) 2022901850

(51) Int. Cl. E04G 21/04; B25J 9/16; B25J 13/08; B25J 15/00; B28B 1/00; B28B 17/00; B33Y 30/00; B33Y 50/02; F04B 1/02; F04B 49/22; G05D 7/06

(52) U.S. Cl. CPC E04G 21/0463; B25J 9/1638; B25J 9/1664; B25J 13/088; B25J 15/0019; B25J 15/0066; B28B 1/001; B28B 17/0081; B33Y 30/00; B33Y 50/02; F04B 1/02; F04B 49/22; G05D 7/0682; B25J 9/1697; E04G 21/0436

(57) ABSTRACT

A robotic construction system for use in constructing a structure, the construction system including a base, a boom extending from the base, an articulated delivery head attached proximate an end of the boom, the delivery head including a nozzle configured to deliver a construction material and a controller configured to control movement of the boom and the delivery head to thereby move the nozzle and deliver construction material, wherein the boom moves with a slower dynamic response over larger distances and the delivery head provides a faster dynamic response over smaller distances.

### BACKGROUND OF THE INVENTION

The present disclosure relates to a system for delivering construction material and in one particular example, machines for 3D construction printing, concrete pumping and delivery, and optionally screeding.

### Description of Prior Art

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

3D printing by extruding cement-based materials for construction is known. Typically these extruders work off a gantry system or if fitted to an articulated arm, the arm has a small area of travel. Typically, the material is delivered through a rubber or flexible hose which often is routed through a cable chain along a linear axis, or hanging from a mast. The rubber hose is small diameter and relatively heavy and expensive and not particularly durable with limited pressure capability (relative to a steel or metal pipe). The low pressure capacity and small diameter of the hose limits the distance that materials can be pumped and limits the rheology of the material and the aggregate size that can be pumped. Consequently, the materials are expensive compared to commercial concrete.

Concrete pumps often have a large 4 or 5 section articulated boom in Z fold or roll fold configurations. Concrete is delivered along the boom by steel pipe that passes through the boom joints by means of rotary connections. Typically, the concrete is finally delivered by a hanging rubber hose at the end of the boom. The hose normally hangs vertically. The long length and light structure results in a relatively flexible boom structure that has a low natural frequency. The booms are typically hydraulically controlled. The hydraulic system often has active damping elements to reduce the bounce of the boom. Movements must be slow and controlled so that the boom does not bounce excessively or dangerously. Even so, the boom end movement is not very accurate and thus the long hanging rubber hose allows an operator to deflect the end nozzle by up to 1 m or so to place the concrete where it is wanted.

It would be desirable to have the set-up speed, reach and durability of a concrete pump boom and steel pipe concrete delivery, combined with the dexterity of a 3D printing machine to enable automated or remote controlled placement of 3D printing materials or concrete.

### SUMMARY OF PRESENT INVENTION

In one broad form, an aspect of the present invention seeks to provide a robotic construction system for use in constructing a structure, the construction system including: a base; a boom extending from the base; an articulated delivery head attached proximate an end of the boom, the delivery head including a nozzle configured to deliver a construction material; and, a controller configured to control movement of the boom and the delivery head to thereby move the nozzle and deliver construction material, wherein the boom moves with a slower dynamic response over larger distances and the delivery head provides a faster dynamic response over smaller distances.

In one embodiment the controller is configured to control the delivery head to dynamically stabilise the nozzle and thereby correct for unintentional movement of the end of the boom.

In one embodiment the controller is configured to control the boom and the delivery head to control movement of the nozzle during delivery of construction material.

In one embodiment the controller is configured to control the boom and the delivery head to deliver construction material along a desired delivery path.

In one embodiment, while construction material is being delivered, the controller is configured to: control the boom so as to move the end of the boom to thereby provide coarsely guided movement of the nozzle relative to the delivery path; and, control the delivery head to move the nozzle to thereby provide fine positioning of the nozzle as the nozzle moves relative to the path.

In one embodiment the controller is configured to control the boom and delivery head to move the nozzle relative to at least part of the delivery path as construction material is delivered substantially continuously.

In one embodiment the delivery head is articulated on two axes to move the nozzle with two degrees of freedom to thereby allow for movement of the nozzle in two orthogonal spatial directions.

In one embodiment the two orthogonal spatial directions are one of: horizontal spatial directions to correct for longitudinal and lateral movement of the end of the boom; one horizontal and one vertical direction to correct for longitudinal and vertical movement of the end of the boom; and, one horizontal and one vertical direction to correct for lateral and vertical movement of the end of the boom.

In one embodiment the delivery head is articulated on three axes to move the nozzle with three degrees of freedom to thereby allow for movement of the nozzle in orthogonal spatial directions.

In one embodiment movement of the nozzle in orthogonal spatial directions is used to correct for longitudinal, lateral and vertical movement of the end of the boom.

In one embodiment the delivery head is articulated with axes to provide one of: pitch, roll, pitch movement; pitch, pitch, roll movement; and pitch, roll and sliding movement.

In one embodiment the delivery head is further articulated on a further axis to adjust a pitch of the nozzle.

In one embodiment the delivery head is articulated on another further axis to adjust an orientation of the nozzle.

In one embodiment the delivery head is articulated using at least one of: a rotational actuator; a linear actuator; a hydraulic motor; an electric motor; a hydraulic ram; an electric ram; a hydraulic servo; and, an electric servo.

In one embodiment one of: the nozzle is arranged substantially vertically to deliver construction material downwardly onto a surface; and, the nozzle is arranged substantially horizontally to deliver construction material laterally onto a surface.

In one embodiment the delivery head includes a robot arm and end effector, and wherein the nozzle is supported by the end effector.

In one embodiment the delivery head includes a working member to work the delivered construction material.

In one embodiment the working member includes one of: a screed member; a trowel; formwork; a mould; and, a biasing member configured to urge working material; a cutting implement; a grinding head; a polishing head; washer head; a sand blast head; and, a guillotine.

In one embodiment the delivery head is articulated to at least one of: independently move the working member and the nozzle; move the working member relative to the nozzle; allow for rotation of the working member around the nozzle; control a height of the working member relative to the nozzle; and, control an orientation of the working member.

In one embodiment the delivery head is articulated about three axes to allow the working member to be maintained in a fixed orientation with a further articulation being provided to allow height and/or positional adjustment of the working member.

In one embodiment the delivery head is articulated to allow rotation and horizontal movement of the working member.

In one embodiment the system includes a boom actuator configured to move the boom.

In one embodiment the boom actuator is configured to at least one of: slew the boom; extend or retract the boom; unfold the boom; and, raise or lower the boom.

In one embodiment the system includes a tracking system configured to measure a position and/or movement of at least one of: the delivery head; the end of the boom; the boom; and, the nozzle; and wherein the controller is configured to control the delivery head in accordance with signals from the tracking system.

In one embodiment the tracking system includes at least one of: a laser guide; a physical guide and corresponding guide sensor; a positioning sensor; a GPS sensor; a movement sensor; an inertial measurement unit; a machine vision system; a laser tracker; a LiDAR; a radar; and, a ranging sensor; and, an ultrasonic ranging sensor.

In one embodiment the tracking system includes: three retroreflectors mounted proximate an end of the boom; and, corresponding laser trackers, wherein the tracking system is configured to measure a position and orientation of the end of the boom based on radiation reflected from the retroreflectors.

In one embodiment the tracking system includes: a retroreflector movably mounted on the articulated head proximate the nozzle; and, a laser tracker, wherein the tracking system is configured to measure a position and orientation of the nozzle based on radiation reflected from the retroreflector.

In one embodiment the tracking system includes: a laser guide positioned in the environment; and, a sensor mounted on at least one of the boom and the delivery head, the sensor being configured to detect deviation from the laser guide.

In one embodiment the laser guide defines at least one of: a height plane; and, a delivery path.

In one embodiment the system includes a delivery pipe configured to transport the construction material from the base, along the boom, to the nozzle.

In one embodiment the delivery pipe includes an articulated steel pipe.

In one embodiment the at least one of the delivery pipe and the boom are formed through articulation of the delivery pipe.

In one embodiment the system includes a hopper configured to receive construction material and a pump configured to pump construction material from the hopper through the pipe.

In one embodiment the pump includes: two pumping cylinders; an associated swing valve for each cylinder, the position of the swing valve adjusting whether the cylinders are filling or dispensing material; and, a controller configured to deliver construction material by: partially emptying one cylinder while the other cylinder is filling; and, transitioning delivery from one cylinder to the other by reducing a delivery rate from one cylinder while increasing a delivery rate from the other cylinder to maintain an overall delivery rate.

In one embodiment the pump includes: a first cylinder containing a first piston driven by a first actuator, the first cylinder being configured to fill with construction material when the first piston is retracted from the first cylinder and deliver construction material when the first piston is extended into the first cylinder; a second cylinder containing a second piston driven by a second actuator, the second cylinder being configured to fill with construction material when the second piston is retracted from the second cylinder and deliver construction material when the second piston is extended into the second cylinder; a first swing valve configured so that in a delivery position the first swing valve connects the first cylinder to the delivery pipe and in a filling position allows construction material to enter the first cylinder; a second swing valve configured so that in a delivery position the second swing valve connects the second cylinder to the delivery pipe and in a filling position allows construction material to enter the second cylinder; a pump controller configured to control the first and second actuators and the first and second swing valves so as to: deliver construction material by partially emptying one cylinder while the other cylinder is filling; and, transition delivery from one cylinder to the other by reducing a delivery rate from one cylinder while increasing a delivery rate from the other cylinder to maintain an overall delivery rate.

In one embodiment the pump controller is configured to: in an initial step: position the first swing valve in the filling position and retract the first piston to fill the first cylinder; position the first swing valve in the delivery position and commence extending the first piston to start delivering construction material from the first cylinder; in a first step: continue extending the first piston to thereby continue delivering construction material from the first cylinder; position the second swing valve in the filling position and retract the second piston to thereby fill the second cylinder; in a second step, once the second cylinder is filled with construction material: extend the first piston at a reducing rate to thereby deliver remaining construction material from the first cylinder; position the second swing valve in the delivery position and commence extending the second piston at an increasing rate to commence delivering construction material from the second cylinder; in a third step, once the first cylinder is empty: position the first swing valve in the filling position and retract the first piston to thereby fill the second cylinder; continue extending the second piston to thereby continue delivering construction material from the second cylinder; in a fourth step, once the first cylinder is filled with construction material: position the first swing valve in the delivery position and commence extending the first piston at an increasing rate to commence delivering construction material from the first cylinder; extend the second piston at a reducing rate to thereby deliver remaining construction material from the second cylinder; repeat the first to fourth steps as needed.

In one embodiment the construction material is at least one of: a viscous fluid; cement based materials; concrete; cement; mortar; shotcrete; a 3D printing material; and, a polymeric material.

In one embodiment the base is part of a vehicle.

In one broad form, an aspect of the present invention seeks to provide a construction material pump including: two pumping cylinders; an associated swing valve for each cylinder, the position of the swing valve adjusting whether the cylinders are filling or dispensing material; and, a controller configured to deliver construction material by: partially emptying one cylinder while the other cylinder is filling; and, transitioning delivery from one cylinder to the other by reducing a delivery rate from one cylinder while increasing a delivery rate from the other cylinder to maintain an overall delivery rate.

In one embodiment the pump includes: a first cylinder containing a first piston driven by a first actuator, the first cylinder being configured to fill with construction material when the first piston is retracted from the first cylinder and deliver construction material when the first piston is extended into the first cylinder; a second cylinder containing a second piston driven by a second actuator, the second cylinder being configured to fill with construction material when the second piston is retracted from the second cylinder and deliver construction material when the second piston is extended into the second cylinder; a first swing valve configured so that in a delivery position the first swing valve connects the first cylinder to the delivery pipe and in a filling position allows construction material to enter the first cylinder; a second swing valve configured so that in a delivery position the second swing valve connects the second cylinder to the delivery pipe and in a filling position allows construction material to enter the second cylinder; a pump controller configured to control the first and second actuators and the first and second swing valves so as to: deliver construction material by partially emptying one cylinder while the other cylinder is filling; and, transition delivery from one cylinder to the other by reducing a delivery rate from one cylinder while increasing a delivery rate from the other cylinder to maintain an overall delivery rate.

In one embodiment the pump controller is configured to: in an initial step: position the first swing valve in the filling position and retract the first piston to fill the first cylinder; position the first swing valve in the delivery position and commence extending the first piston to start delivering construction material from the first cylinder; in a first step: continue extending the first piston to thereby continue delivering construction material from the first cylinder; position the second swing valve in the filling position and retract the second piston to thereby fill the second cylinder; in a second step, once the second cylinder is filled with construction material: extend the first piston at a reducing rate to thereby deliver remaining construction material from the first cylinder; position the second swing valve in the delivery position and commence extending the second piston at an increasing rate to commence delivering construction material from the second cylinder; in a third step, once the first cylinder is empty: position the first swing valve in the filling position and retract the first piston to thereby fill the second cylinder; continue extending the second piston to thereby continue delivering construction material from the second cylinder; in a fourth step, once the first cylinder is filled with construction material: position the first swing valve in the delivery position and commence extending the first piston at an increasing rate to commence delivering construction material from the first cylinder; extend the second piston at a reducing rate to thereby deliver remaining construction material from the second cylinder; repeat the first to fourth steps as needed.

In one embodiment the pump includes: a first sensor configured to measure a position of the first piston; and, a second sensor configured to measure a position of the second piston, and wherein the controller is configured to control the first and second actuators in accordance with signals from the first and second sensors. It will be appreciated that the broad forms of the invention and their respective features can be used in conjunction and/or independently, and reference to separate broad forms is not intended to be limiting.

### BRIEF DESCRIPTION OF THE DRAWINGS

Various examples and embodiments of the present invention will now be described with reference to the accompanying drawings, in which:

FIG. 1A is a schematic diagram of a system for delivering construction material;

FIG. 1B is a schematic plan view of the system of FIG. 1A;

FIG. 2 is a schematic diagram of an example of a control system for the system of FIG. 1A;

FIG. 3 is a schematic diagram of a further example of a system for delivering construction material;

FIG. 4 is a schematic diagram of an example of a delivery head;

FIG. 5 is a schematic diagram of a further example of a delivery head;

FIG. 6 is a schematic diagram of a further example of a delivery head incorporating a robotic arm;

FIG. 7 is a schematic diagram of the end effector of the robotic arm of FIG. 6;

FIG. 8 is a schematic diagram of an example of a replacement head for a block laying machine using a triple tracker tracking system;

FIG. 9 is a schematic diagram of an example of a replacement head for a block laying machine using a single tracker tracking system;

FIG. 10 is a schematic diagram of an example of a 3D printing machine;

FIG. 11 is a schematic diagram of an alternative example of a 3D printing machine;

FIGS. 12 to 14 are schematic diagrams of examples of delivery head articulation for a material delivery system;

FIG. 15A is a schematic diagram of an example of delivery head articulation for a material delivery system;

FIG. 15B is a schematic diagram of an example of delivery head articulation for a material delivery system;

FIGS. 16 to 22 are schematic diagrams of further examples of delivery head articulation for a material delivery system;

FIG. 23A is an end view of an example of a known configuration of a concrete pump;

FIG. 23B is a plan view of the concrete pump of FIG. 23A;

FIG. 24 is a plan end view of an example of a concrete pump;

FIG. 25A is a schematic diagram of an example of a system for working construction material;

FIG. 25B is a schematic diagram of an alternative view of the working machine of FIG. 25A;

FIG. 25C is a schematic diagram of an example of the working head of the working machine of FIG. 25A including a screed bar working member;

FIG. 25D is a schematic diagram of an example of a wire tie working member;

FIG. 25E is a schematic diagram of an example of a helicopter trowel working member;

FIG. 26A is a schematic diagram of a further example of a system for working construction material with the boom in a folded position;

FIG. 26B is a schematic diagram of the system of FIG. 26A with the boom in an extended position;

FIG. 26C is a schematic diagram of the delivery head of the system of FIG. 26A;

FIG. 27A is a schematic diagram of an example of a screed bar including attachable trowels;

FIG. 27B is a schematic diagram of an example of a screed bar including deployable trowels;

FIG. 28 is a schematic diagram of an example of a tracking system including a laser level; and,

FIG. 29 is a schematic diagram of an example of boom stick extension mechanism.

### DETAILED DESCRIPTION OF THE PREFERRED EMBODIMENTS

The following description explains a number of different systems and methods for delivering construction material to within an environment. For the purpose of illustration, the following definitions apply to terminology used throughout.

The term “delivery” is intended to refer to dispensing the construction material in situ to a desired location, including one or more discrete locations, as well as continuous or semi-continuous delivery over a defined region or path.

The term “working” is intended to refer to interacting with, and more typically manipulating construction material in situ. This typically involves some form of mechanical manipulation, such as moving or forming the construction material, and could include specific tasks such as screeding, trowelling, or the like. However, this could also encompass other tasks such as grinding or polishing, as well as washing or chemical treatment. Further examples will be described in more detail below.

A “construction material” is a material used in construction, and in particular is typically a viscous fluidic material that can be cured or otherwise solidified in situ to form part of a construction. Examples of construction materials include, but are not limited to cement based materials, such as concrete, cement, mortar, shotcrete, or the like, as well as polymeric materials, such as a 3D printing materials. The materials can include additives, such as fibre reinforcement, and it will be appreciated from this that a wide range of construction materials are envisaged.

The term “environment” is used to refer to any location, region, area or volume within which, or on which, construction material can be delivered. The type and nature of the environment will vary depending on the preferred implementation and the environment could be a discrete physical environment, and/or could be a logical physical environment, delineated from surroundings solely by virtue of this being a volume within which interactions occur. Non-limiting examples of environments include building or construction sites, parts of vehicles, such as decks of ships or loading trays of lorries, factories, loading sites, ground work areas, or the like, and further examples will be described in more detail below.

A “robot arm” is a programmable mechanical manipulator. In this specification a robot arm includes multi axis jointed arms, parallel kinematic robots (such as Stewart Platform, Delta robots), spherical geometry robots, Cartesian robots (orthogonal axis robots with linear motion) etc.

A “delivery head” is a programmable mechanical manipulator that is capable of delivering construction material. In this specification the delivery head could include a robot arm, but could include other suitable articulated arrangements capable of positioning a nozzle that delivers construction material.

A “working head” is a programmable mechanical manipulator that is capable of working construction material. In this specification the working head could include a robot arm, but could include other suitable articulated arrangements capable of positioning a working member to work construction material.

Where a head performs the dual functionality of delivering and working construction material, the head could be considered a working or a delivery head, and the two terms should be considered as interchangeable in this scenario.

A “boom” is an elongate support structure such as a slewing boom, with or without stick or dipper, with or without telescopic elements, telescoping booms, telescoping articulated booms. Examples include crane booms, earthmover booms, truck crane booms, all with or without cable supported or cable braced elements. A boom may also include an overhead gantry structure, or cantilevered gantry, or a controlled tensile truss (the boom may not be a boom but a multi cable supported parallel kinematics crane (see PAR systems, Tensile Truss-Chernobyl Crane)), or other moveable arm that may translate position in space.

An “end effector” is a device at the end of a robotic arm designed to interact with the environment. An end effector may include a gripper, nozzle, sand blaster, spray gun, wrench, magnet, welding torch, cutting torch, saw, milling cutter, router cutter, hydraulic shears, laser, riveting tool, or the like, and reference to these examples is not intended to be limiting.

TCP is an abbreviation of tool centre point. This is a location on the end effector or part of the delivery head, such as the nozzle, whose position and orientation are derivable and controllable. It is typically located at the distal end of the kinematic chain. Kinematic chain refers to the chain of linkages and their joints within the delivery head and/or between the base of a robot arm and the end effector.

CNC is an abbreviation for computer numerical control, used for automation of machines by computer/processor/microcontroller executed pre-programmed sequences of machine control commands.

The application of coordinate transformations within a CNC control system is usually performed to allow programming in a convenient coordinate system. It is also performed to allow correction of workpiece position errors when clamped in a vice or fixture on a CNC machining centre.

These coordinate transformations are usually applied in a static sense to account for static coordinate shifts or to correct static errors.

Robots and CNC machines are programmed in a convenient Cartesian coordinate system, and kinematic transformations are used to convert the Cartesian coordinates to joint positions to move the pose of the robot or CNC machine.

Measuring the position of a robot arm end effector close to the TCP in real time increases the accuracy of a robot. This is performed on static end effectors on robots used for probing and drilling. This is achieved by a multi-step process of moving to the programmed position, taking a position measurement, calculating a correction vector, adding the compensation vector to the programmed position and then moving the TCP to the new position. This process is not done in hard real time and relies on a static robot arm pose.

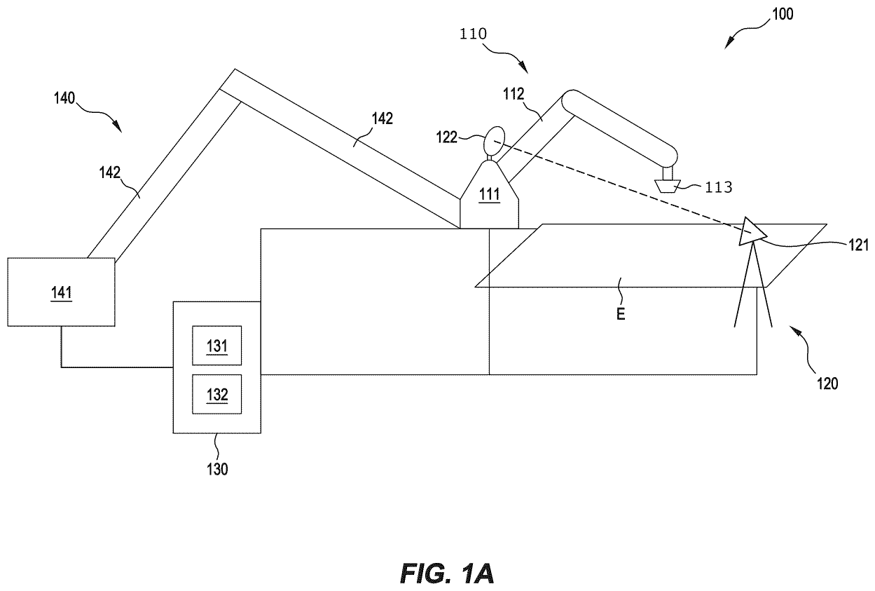

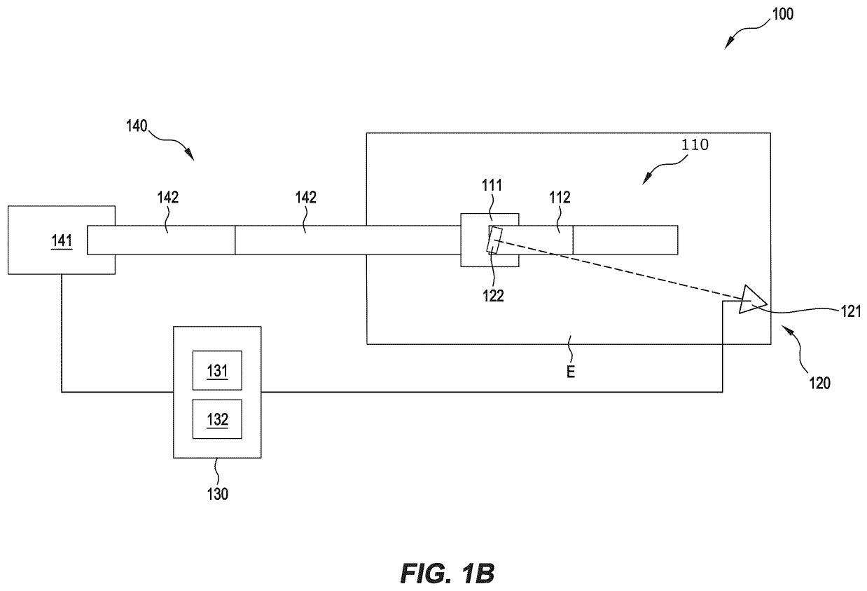

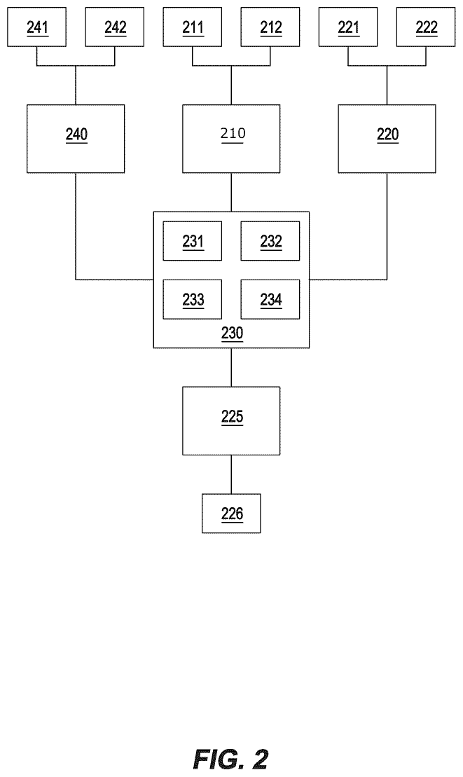

An example system for delivering construction material within a physical environment will now be described with reference to FIGS. 1A, 1B and FIG. 2.

In the example of FIG. 1A the system 100 includes a base 141, a boom 142 extending from the base, and an articulated delivery head 110 attached proximate an end of the boom 142, the delivery head including a nozzle 113 configured to deliver a construction material. A controller 130 is also provided to control movement of the boom 142 and the delivery head 110, thereby allowing movement of the nozzle to be controlled so as to deliver construction material into the environment.

Some further example details will now be described to provide context to the above described system, however as will be appreciated from the following description, these are example features and are not necessarily meant to be limiting.

In this example, the delivery head 110 includes a support 111, a robot arm 112 and a nozzle 113. The delivery head 110 is positioned relative to an environment E, which in this example is illustrated as a 2D plane, but in practice could be a 3D volume of any configuration. In use, the nozzle 113 is used to deliver construction material within the environment E, for example to deliver concrete, or the like. The particular form of the delivery head 110 will vary depending on the preferred implementation and further examples will be described in more detail below.

The delivery head 110 is supported by a robot base actuator 140, which can be used to move the robot base. In this example, the robot base actuator is in the form of a boom assembly including a boom base 141, and a boom 142 including a plurality of boom elements. The boom is typically controllable allowing a position and/or orientation of the robot base to be adjusted. The types of movement available will vary depending on the preferred implementation. For example, the boom base 141 could be mounted on a vehicle allowing this to be positioned and optionally rotated to a desired position and orientation. The boom 142 can include telescopic and/or folding arrangements, including a number of telescoping/folding boom or stick members, allowing a length of the boom or stick to be adjusted. Additionally, angles between the boom base 141 and boom 142, and different elements within the boom 142, can be controlled, for example using hydraulic actuators, allowing the delivery head 110 to be provided in a desired position relative to the environment E.

The system 100 can include a tracking system 120, which is able to track the delivery head movement, and in one particular example, movement of the delivery head relative to the environment. In one example, the tracking system includes a tracker base 121, which is typically statically positioned relative to the environment E and a tracker target 122, mounted on the support 111, allowing a position of the delivery head 110 relative to the environment E to be determined. However, it will be appreciated that other tracking arrangements could be used. For example, other position/movement sensors, such as an inertial measurement unit (IMU) can additionally and alternatively be used, as will be described in more detail below. The current example is therefore for the purpose of illustration only and should not be considered limiting.

A control system 130 is provided in communication with the delivery head 110, and optionally the tracking system 120, allowing the delivery head to be controlled, optionally based on signals received from the tracking system. The control system typically includes one or more control processors 131 and one or more memories 132. For ease of illustration, the remaining description will make reference to a processing device and a memory, but it will be appreciated that multiple processing devices and/or memories could be used, with reference to the singular encompassing the plural arrangements. In use the memory stores control instructions, typically in the form of applications software, or firmware, which is executed by the processor 131 allowing signals from the tracking system 120 and robot assembly 110 to be interpreted and used to control the robot assembly 110 to allow interactions to be performed.

An example of the control system 130 is shown in more detail in FIG. 2.

In this example the control system 230 is coupled to a delivery head controller 210, a tracking system controller 220 and a boom controller 240. The delivery head controller 210 is coupled to one or more actuators 211, 212, which are able to control positioning of the nozzle 113. The tracking system controller 220 is coupled to the tracking head 221 and target 222, allowing the tracking system to be controlled and relative positions of the tracking head 221 and target 222 to be ascertained and returned to the control system 230. The boom controller 240 is typically coupled to boom actuators 241, 242 which can be used to position the boom and hence robot base. A second tracking system 225 may additionally and/or alternatively be provided, which includes sensors 226, such as inertial sensors, optionally coupled to a controller or processor. It is to be understood that in practice the delivery head and boom will have multiple actuators such as servo motors, hydraulic cylinders and the like to effect movement of their respective axes (i.e. joints) and reference to single actuators is not intended to be limiting.

Each of the robot arm controller 210, tracking system controller 220, second tracking system 225 and boom controller 240 typically include electronic processing devices, operating in conjunction with stored instructions, and which operate to interpret commands provided by the control system 230 and generate control signals for the respective actuators and/or the tracking system and/or receive signals from sensors and provide relevant data to the control system 230. The electronic processing devices could include any electronic processing device such as a microprocessor, microchip processor, logic gate configuration, firmware optionally associated with implementing logic such as an FPGA (Field Programmable Gate Array), or any other electronic device, system or arrangement. It will be appreciated that the robot arm controller 210, tracking system controller 220 and boom controller 240 typically form part of the boom assembly, robot assembly and tracking system, respectively. As the operation of such systems would be understood in the art, these will not be described in further detail.

The control system 230 typically includes an electronic processing device 231, a memory 232, input/output device 233 and interface 234, which can be utilised to connect the control system 230 to the robot arm controller 210, tracking system controller 220 and boom controller 240. Although a single external interface is shown, this is for the purpose of example only, and in practice multiple interfaces using various methods (eg. Ethernet, serial, USB, wireless or the like) may be provided.

In use, the processing device 231 executes instructions in the form of applications software stored in the memory 232 to allow the required processes to be performed. The applications software may include one or more software modules, and may be executed in a suitable execution environment, such as an operating system environment, or the like.

Accordingly, it will be appreciated that the control system 230 may be formed from any suitable processing system, such as a suitably programmed PC, computer server, or the like. In one particular example, the control system 230 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

It will also be appreciated that the above described arrangements are for the purpose of illustration only and practice a wide range of different systems and associated control configurations could be utilised. For example, it will be appreciated that the distribution of processing between the controllers and/or control system could vary depending on the preferred implementation.

An example of a system of this form for laying blocks is described in US8166727, WO2009/026641, WO2009/026642, WO2018/009981, WO2018/009986 and WO2019/014701 and US20210379775 the content of which is incorporated herein by cross reference. However, in this example, instead of laying blocks the arrangement is configured to deliver construction material through a nozzle, which in turn leads to a number of different factors, in turn affecting the implementation.

Typically, the boom assembly can have a significant length, so for example in the case of a construction application, the boom may need to extend across a construction site and could have a length of tens of meters. In such circumstances, the boom is typically subject to a variety of loads, including forces resulting from movement of the boom and/or delivery head, movement of construction material along the boom, wind loading, machinery vibrations, or the like, which can in turn induce oscillations or other movement in the end of the boom, in turn causing the robot base to move relative to the environment. Such movement will be referred to generally as unintentional movement.

Additionally, the delivery head can be moved in a controlled manner by actively moving the boom. This is typically performed to move the nozzle during delivery of material, for example to lay construction material along a path, such as a top of a wall, or other structure, and such movement will be referred to generally as intentional movement.

Additionally, by virtue of the relative sizes, notably the order of tens of meters for the boom, and a meter or less for the delivery head mechanisms, any movement of the boom is necessarily slower than movement of the delivery head.

As a result, in practice, when the system is being used, it is typically necessary to guide the nozzle so as to deliver construction material to a specific construction location or area. For example, when constructing a wall, it is typically necessary to guide the nozzle along the intended extent of the wall in multiple passes, to thereby progressively construct the wall from the construction material. It will be appreciated that this can be performed in a manner similar to 3D printing.

During this process, coarse movements of the nozzle are achieved by moving the boom, for example by slewing the boom and adjusting the boom length, so that the nozzle roughly traverses the intended delivery path. Simultaneously, the delivery head 110 can be controlled to provide fine positional adjustment, and specifically to ensure the nozzle follows the intended delivery path. This is performed both to counter unintentional movement of the end of the boom, but also to overcome limitations in the ability to finely control the end of the boom by moving the boom alone.

Thus it will be appreciated that in the above arrangement, the boom moves with a slower dynamic response over larger distances, whilst the delivery head provides a faster dynamic response over smaller distances, and that the controller controls both the boom and the delivery head to move the nozzle so as to deliver construction material.

For the sake of clarity, as used above the terms “larger” and “smaller” are relative, so a “slower dynamic response” is merely slower than a “faster dynamic response”, whilst a “larger distance” is merely greater than a “smaller distance”.

In any event, it will be appreciated that the combination of the fine fast response of the delivery head can be used to account for limitations in the ability to finely control the end of the boom and also to address the issue of unintentional movement of the end of the boom. This form of operation is referred to by the applicant as dynamic stabilisation technology (DST) and is described in prior publications including US8166727 WO2009/026641, WO2009/026642, WO2018/009981 and WO2018/009986, the contents of which are incorporated herein by cross reference.

An example of a number of different aspects of the above described system will now be described in further detail. These different aspects of the system can be used independently or can be used in conjunction depending on the preferred implementation. It will be appreciated from this that reference to separate aspects should not be considered limiting and that aspects can be used in any number of different combinations, depending on the preferred implementation and the scenario in which the system is used.

As mentioned above, the controller can be configured to control the boom and the delivery head to control movement of the nozzle during delivery of construction material, specifically for example to deliver construction material along a desired delivery path. This generally involves having the controller control the boom so as to move the end of the boom to thereby provide coarsely guided movement of the nozzle relative to the delivery path and simultaneously control the delivery head to move the nozzle to thereby provide fine positioning of the nozzle as the nozzle moves relative to the path. This in turn allows construction material to be delivered continuously, or at least substantially continuously, as the nozzle moves, thereby ensuring continuity of the construction material within the resulting construction.

To achieve the required control, the delivery head is typically articulated on at least two axes to move the nozzle with two degrees of freedom to thereby allow for movement of the nozzle in two orthogonal spatial directions. In this regard, it will be appreciated that minimising the degrees of freedom of articulation of the delivery head will reduce delivery head complexity, but potentially at the expense of limiting the accuracy of nozzle positioning in other spatial directions or orientations. Accordingly, the particular configuration of the delivery head may be varied depending on the particular usage scenario.

For example, the delivery head can be configured to move the nozzle over horizontal spatial directions to correct for longitudinal and lateral movement of the end of the boom. This allows for correction and/or compensation in slew and extension/retraction movements of the boom. In this example, vertical movement of the boom is not compensated for, but this may be less critical in some situations, such as if the system is delivering construction material vertically downwardly onto a surface or other structure. In this instance, rough positioning of the nozzle in a vertical direction may provide sufficient accuracy, in which case positional adjustment in horizontal direction is all that is required.

Alternatively, the axes may allow for positional adjustment in one horizontal and one vertical direction to correct for longitudinal or lateral movement, as well as vertical movement, of the end of the boom. In this instance, accurate compensation can be provided for extension/retraction or slew of the boom, as well as the boom end height.

In other applications, the delivery head can be articulated on three axes to move the nozzle with three degrees of freedom to thereby allow for movement of the nozzle in orthogonal spatial directions, which can be used to correct for longitudinal, lateral and vertical movement of the end of the boom.

To provide three degrees of movement, the delivery head can be articulated in a variety of manners, for example, providing the delivery head with axes to provide one of: pitch, roll, pitch movement; pitch, pitch, roll movement; or pitch, roll and sliding movement. Further examples of such arrangements will be described in more detail below.

Although not essential, in some arrangements, the delivery head can be articulated on a further axis (or third axis in a two degree of spatial movement arrangement) to adjust a pitch of the nozzle. Generally adjustment of the nozzle pitch when delivering construction material is less critical, and the nozzle pitch can vary, for example depending on the orientation of other axes, without adversely affecting the delivery of the construction material. Similarly, the delivery head can be articulated on a further axis to adjust an orientation of the nozzle (e.g: to adjust a yaw and/or roll).

However, this is not essential and fixed nozzle orientations and pitches could be used, for example, having the nozzle arranged substantially vertically to deliver construction material downwardly onto a surface or having the nozzle arranged substantially horizontally to deliver construction material laterally onto a surface, for example when shotcreting a wall, embankment or the like.

The delivery head can be articulated using a number of different arrangements, including any one or more of a rotational actuator, a linear actuator, a hydraulic motor, an electric motor, a hydraulic ram, an electric ram, a hydraulic servo, an electric servo, or the like. The exact nature of the actuators will vary depending on the preferred implementation, and some examples will be described in further detail below.

In one example, the delivery head includes a robot arm and end effector, and wherein the nozzle is supported by the end effector, although this is not essential and in other examples, the nozzle is integrated directly into the delivery head, avoiding the need for a separate end effector.

In one example, the delivery head includes a working member to work the delivered construction material. In this regard, in addition to simply delivering the material, additional actions might be desired in order to shape or otherwise arrange the material. Examples of this include screeding the material to ensure a level surface, or shaping the material to provide a particular shape when the material cures, or otherwise solidifies. Example working members include, but are not limited to a screed member, a trowel, formwork, a mould, a biasing member configured to urge working material, a cutting implement, a grinding head, a polishing head, washer head, a sand blast head, a guillotine, or the like.

The working member could be provided in a fixed arrangement relative to the nozzle, which might be sufficient to ensure desired working is achieved, depending on the usage scenario. For example, a formwork might be attached to the nozzle to shape the material as it is delivered, for example to guide the material into a generally rectangular shape for use when constructing walls or similar. However, in other examples, the delivery head can be articulated to allow a position of the working member to be adjusted relative to the nozzle. This can be used to move the working member relative to the nozzle, for example to allow for rotation of the working member around the nozzle, so the working member can be provided in a trailing arrangement, depending on the direction of movement of the nozzle. This could additionally and/or alternatively be used to control a height of the working member relative to the nozzle, or to maintain a particular orientation of the working member, important for example in the case of screeding.

In one example, the delivery head is articulated about three axes to allow the working member to be maintained in a fixed orientation with a further articulation being provided to allow height and/or positional adjustment of the working member. This can ensure that as the boom and/or delivery head are moved to alter the nozzle position, which may result in some change in nozzle orientation, the working member can be maintained at a specific orientation, such as vertical, whilst also separately allowing a height of the working member to be controlled.

The delivery head can also be articulated to allow rotation and horizontal movement of the working member, for example allowing a screeding member to rotate to provide screed functionality, and allowing horizontal movement to ensure all parts of a surface can be screeded.

In one example, as described above, the system includes a boom actuator configured to move the boom. This is typically configured to slew the boom, extend the boom, unfold the boom or raise or lower the boom, and may be achieved using hydraulic or servo electric actuators, such as hydraulic rams, servo motors or similar.

As also previously mentioned, the system typically includes a tracking system configured to measure a position and/or movement of the delivery head, the end of the boom, the boom and/or the nozzle. In this regard, as the nozzle position is typically known relative to the end of the boom by virtue of the kinematics of the delivery head, as long as one of the above mentioned positions is known, the others can usually be easily derived. The controller is then typically configured to control the delivery head in accordance with signals from the tracking system.

The nature of the tracking system will vary depending on the implementation. For example the tracking system could include any one or more of a laser guide, a physical guide and corresponding guide sensor, a positioning sensor, a GPS sensor, a movement sensor, an inertial measurement unit, a machine vision system, a laser tracker, a LiDAR, a radar, a ranging sensor or an ultrasonic ranging sensor.

For example, in one specific arrangement, the tracking system 120 includes a tracking base 121 including a tracker head having a radiation source arranged to send a radiation beam to the target 122 and a base sensor that senses reflected radiation. A base tracking system is provided which tracks a position of the target 122 and controls an orientation of the tracker head to follow the target 122. The target 122 typically includes a target sensor that senses the radiation beam and a target tracking system that tracks a position of the tracking base and controls an orientation of the target to follow the tracker head. Angle sensors are provided in the head and the target that determine an orientation of the head and target respectively. A tracker processing system determines a relative position of the tracker base and target in accordance with signals from the sensors, specifically using signals from the angle sensors to determine relative angles of the tracker and target, whilst time of flight of the radiation beam can be used to determine a physical separation. In a further example, the radiation can be polarised in order to allow an orientation of the base relative to the tracking head to be determined. Although a single tracking system 120 including a head and target is shown, this is not essential and in other examples multiple tracking systems and/or targets can be provided as will be described in more detail below.

For example, the tracking system can include three retroreflectors mounted proximate an end of the boom and corresponding laser trackers, wherein the tracking system is configured to measure a position and orientation of the end of the boom based on radiation reflected from the retroreflectors. Alternatively, the tracking system can include a retroreflector movably mounted on the articulated head proximate the nozzle and a laser tracker, wherein the tracking system is configured to measure a position and orientation of the nozzle based on radiation reflected from the retroreflector.

In one particular example, the tracking system is a laser tracking system and example arrangements are manufactured by API (Radian and OT2 with STS (Smart Track Sensor)), Leica (AT960 and Tmac) and Faro. These systems measure position at 300 Hz, or 1 kHz or 2 kHz (depending on the equipment) and rely on a combination of sensing arrangements, including laser tracking, vision systems using 2D cameras, accelerometer data such as from a tilt sensor or INS (Inertial navigation System) and can be used to make accurate position measurements of position, with data obtained from the laser tracker and active target equating to position and optionally orientation of the active target relative to the environment E. As such systems are known and are commercially available, these will not be described in any further detail.

Such systems provide a high degree of accuracy (typically sub-millimetre) and low latency (a few microseconds), making these particularly suited to scenarios where a high degree of accuracy is required. However, in material delivery applications, high accuracy might be less important. For example, in some situations additional working of the material, such as screeding, might be performed, and so exact positioning of the nozzle is less critical. Similarly, in some scenarios, the working material might undergo flow or slump after delivery, so again positioning of the nozzle might only be required to within a few millimetres or centimetres, as opposed to sub-millimetre accuracy. As laser tracking systems can be expensive, in these situations, more basic tracking could be used. For example, a combination of GPS and IMUs, might provide sufficient accuracy.

Alternatively, a laser guide positioned in the environment could be used with, a sensor mounted on the boom, the delivery head or nozzle, with the sensor being configured to detect deviation from the laser guide. In this instance, the laser guide can be used to define a height plane and/or a delivery path. Thus, in this example, a laser beam can be used to act as a path along which the nozzle moves, with optical sensors detecting deviation from the beam, and the controller compensating by adjusting the delivery head as needed.

Typically, the system includes a delivery pipe configured to transport the construction material from the base, along the boom, to the nozzle. Whilst rubber hose can be used, this is typically subject to wear, particularly given that the boom can undergo changes in configuration, which can result in bends in the pipe. Accordingly, in another example, the delivery pipe can include an articulated steel pipe.

Furthermore, in some examples, the boom and/or delivery head are formed from articulated delivery pipe, so that the pipe forms the physical structure of the boom and/or delivery head. In this instance it will be appreciated that the boom and the delivery head can be physically constructed from parts of the delivery pipe and the functional difference between these two portions of the system is defined in terms of the size of the components, and the manner of their actuation and hence their responsiveness to articulation. For example, pipe sections in the boom could be several meters in length and articulated using hydraulic rams, whereas pipe sections in the delivery head could be less than a meter in length and actuated using smaller rams, and/or rotary or linear actuators, and optionally electronic or pneumatic actuators. In this instance, the reduced size and weight of the pipe sections in the delivery head allows for actuation using smaller lighter weight and faster actuators, in turn resulting in improved responsiveness and hence a faster dynamic response than the boom.

The system generally includes a hopper configured to receive construction material and a pump configured to pump construction material from the hopper through the pipe. Typical pumps for pumping cement are intermittent, which can place stress on the boom and additionally lead to large boom oscillations, which in turn places additional burden on operation of the delivery head.

Accordingly, in one example, the above described system can be used in conjunction with a continuous flow pump. In this example, the pump includes two pumping cylinders, each having an associated swing valve the position of which adjusts whether the cylinders are filling or dispensing material. The pump includes a controller, which is configured to deliver construction material by partially emptying one cylinder while the other cylinder is filling and then transition delivery from one cylinder to the other by reducing a delivery rate from one cylinder while increasing a delivery rate from the other cylinder to maintain an overall delivery rate.

More specifically, the pump includes a first cylinder containing a first piston driven by a first actuator, the first cylinder being configured to fill with construction material when the first piston is retracted from the first cylinder and deliver construction material when the first piston is extended into the first cylinder and a second cylinder containing a second piston driven by a second actuator, the second cylinder being configured to fill with construction material when the second piston is retracted from the second cylinder and deliver construction material when the second piston is extended into the second cylinder. The pump further includes a first swing valve configured so that in a delivery position the first swing valve connects the first cylinder to the delivery pipe and in a filling position allows construction material to enter the first cylinder and a second swing valve configured so that in a delivery position the second swing valve connects the second cylinder to the delivery pipe and in a filling position allows construction material to enter the second cylinder.

In operation, the controller delivers construction material by partially emptying one cylinder while the other cylinder is filling and transitions delivery from one cylinder to the other by reducing a delivery rate from one cylinder while increasing a delivery rate from the other cylinder to maintain an overall delivery rate. More specifically:

In an initial step, the controller positions the first swing valve in the filling position and retracts the first piston to fill the first cylinder and positions the first swing valve in the delivery position and commences extending the first piston to start delivering construction material from the first cylinder.

Following this, in a first step, the controller continues extending the first piston to thereby continue delivering construction material from the first cylinder and positions the second swing valve in the filling position and retracts the second piston to thereby fill the second cylinder.

In a second step, once the second cylinder is filled with construction material, the controller extends the first piston at a reducing rate to thereby deliver remaining construction material from the first cylinder and positions the second swing valve in the delivery position and commences extending the second piston at an increasing rate to commence delivering construction material from the second cylinder.

In a third step, once the first cylinder is empty, the controller positions the first swing valve in the filling position and retracts the first piston to thereby fill the first cylinder and continues extending the second piston to thereby continue delivering construction material from the second cylinder.

In a fourth step, once the first cylinder is filled with construction material, the controller positions the first swing valve in the delivery position and commences extending the first piston at an increasing rate to commence delivering construction material from the first cylinder and extends the second piston at a reducing rate to thereby deliver remaining construction material from the second cylinder.

The first through fourth steps are then repeated as needed.

In one example, the pump includes a first sensor configured to measure a position of the first piston and a second sensor configured to measure a position of the second piston. Whilst the sensors could measure the piston positions directly, more typically this is achieved by measuring the actuator position, which is a proxy for the piston position. The controller is then configured to control the first and second actuators in accordance with signals from the first and second sensors, which can be used to ensure accurate pump control.

It will be appreciated that the above described pumping arrangement can also be used independently, and specifically has application in any scenario where a viscous fluid requires pumping and preferably continuous pumping. Use in the above described construction system is therefore not intended to be limiting.

A number of specific applications and usage scenarios will now be described in further detail.

The applicant has developed a block laying robot that comprises a long telescopic and folding boom that slews about the base of a mobile truck. A block laying and adhesive applying head is mounted to a distal end of the boom. An end effector of the head (e.g. clamp that places a block) is able to be dynamically stabilised using the applicant's proprietary Dynamic Stabilisation System (DST) which is described in prior publications including US8166727, WO2009/026641, WO2009/026642, WO2018/009981, WO2018/009986 and WO2019/014701, the contents of which are incorporated herein by cross reference.

DST is a method and system for stabilising a robotic end effector in real time by performing dynamic compensation to correct for positional error of the end effector as a result of dynamic forces acting on the robot or support thereof. The system uses at least one robot having a faster dynamic response than the dynamic input that is being compensated. In one non-limiting form, a DST system includes a first robot having a slow dynamic response for coarsely positioning the end effector and a second robot coupled to the first robot and having the end effector mounted thereto, said second robot having a fast dynamic response for finely positioning the end effector. Thus a large and relatively light and flexible structure can be used to approximately position a fast and accurate fine positioning mechanism, which can be accurately controlled in real time allowing an end effector to be moved relative to an environment in an accurate and fast motion.

The present disclosure describes embodiments of DST enabled long boom machines for construction 3D printing, concrete pumping and delivery and material working such as screeding. These machines enable an end effector (e.g. delivery nozzle, screed head) to be dynamically stabilised as the boom is traversed over the work zone (i.e. continuous path DST).

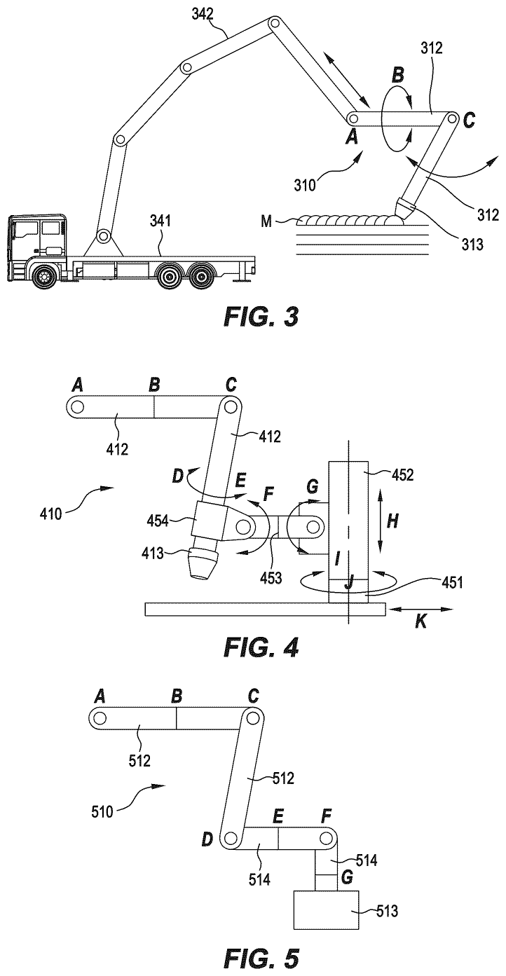

Throughout the following figures, similar reference numerals are used to denote similar features, albeit with a prefix in the hundreds corresponding to the respective figure number. So for example, a nozzle is denoted 113 in FIGS. 1 and 313 in FIG. 3.

FIG. 3 below shows an example of a concrete pump including a vehicle 341 with a delivery head 310 attached to the end of a boom 342 in place of the normal hanging hose used in traditional concrete delivery arrangements.

The articulating delivery head 310 has 3 rotary joints A, B, C provided in articulated members 312 supporting a nozzle 313, which delivers construction material M. The members 312 could be part of a robot arm or other manoeuvrable structure that supports a flexible delivery pipe and/or articulated pipe segments. Alternatively, the members 312 could be made from articulated pipe segments themselves. In any event, the resulting pipe can then be used to deliver construction material to the nozzle 313.

The first pitch joint A pivots in the plane of the boom with a horizontal axis parallel to the boom articulation joints which have horizontal axes. The joint B provides Roll motion. The joint C provides a second tilted axis. By combining motion of A, B and C, the end of the nozzle 313 can be moved in three linear orthogonal dimensions. For concrete delivery, the angle of the nozzle is not critical. Typical dimensions of the two links would be approximately 500 mm long. With approximately +/−15 degrees of angular motion on B and C, the linear movement at the nozzle would be approximately 500×Cos15deg=+/−130 mm.

The Joints ABC are moved automatically by the controller using suitable actuators (not shown) such as servo motors, or the like, to thereby stabilise the motion of the end of the nozzle 313 or to maintain the nozzle 313 at a position or on a path at a desired feed speed or on a desired curved surface or flat plane. Motion may be sensed by a tracking system, laser plane and line sensors or inertial measurements or by a combination of sensors. As an example of a sensing system, a magnetic or capacitive sensor could detect the distance and direction to steel rebar and maintain the nozzle at a set height above the rebar and follow the direction of the rebar. The boom would provide slow dynamic response and large movements, while axes ABC would provide fast dynamic response over a small relative distance.

Other sensing and guidance scenarios include:
a) maintaining constant height by PSDs sensing a rotating laser plane.
b) Following a taught wire or string similar to a kerbing machine guidance system.
c) Following a laser line.
d) Following a trajectory by measuring DGPS (Differential GPS) signals with fine motion measured by an IMU.
e) Machine vision.
f) Ultrasonic distance sensors for maintaining height above ground.
g) Laser tracker or total station optical measurement.

For concrete placement it is necessary to screed concrete so that a flat surface is obtained. FIG. 4 shows a delivery head 410 including additional joints and a screed board 451 supported from articulated members 412 by a linear actuator 452, an articulated bracket 453 and rotatable mounting 454. The first joint D allows the screeding mechanism to rotate around the delivery nozzle so that it can be located in a trailing location relative to the delivery nozzle and boom movement. Joints E, F and G provide 3 axis wrist movement to allow the screeding arm to be kept horizontal with a sliding axis H kept vertical. Axis H allows height adjustment of the screed. Axis J provides rotation around a vertical axis and Axis K provides horizontal screeding motion and allows the screed to sweep into corners and around obstacles such as pipes and rebar and columns.

For 3D printing the nozzle orientation may be important. FIG. 5 shows an articulating delivery head 510 similar to that of FIG. 3, with additional members 514 attached to articulated members 512, having axes D, E, F that provide wrist orientation motion and pipe material to a trowelling nozzle 513 which rotates about axis G.

Measurement, stabilisation and control allows a long boom to deliver material accurately and finish screed or trowel the material. Compared to the use of hoses, the above examples utilise a large pipe diameter that enables high flow rates and large aggregate to be used. High pressure allows long distance pumping. Standard concrete pump pipes and joints allow easy cleaning and known reliability.

3D printing is essentially a 3D task, not a 6D task like laying blocks. Therefore the print nozzle only needs to be positioned in 3 dimensions (xyz) and its orientation need only be maintained within say 10 degrees of vertical and its yaw angle does not matter. If the position can be measured close to the end of the nozzle, then a 3D rather than 6D tracking system would be adequate.

It is advantageous with pumping concrete and cement based materials for 3D printing to avoid rubber hose (wear, stretching of hose, large bend radius for high pressure and pulsing of material flow). It is better to use steel pipe. This it is advantageous to avoid linear motion axes and use articulated or revolute joints (bending joints).

Embodiments of this disclosure relate to concepts for a dynamically stabilised 3D printing nozzle that can be fitted to the end of a boom to provide a nozzle that is accurate in 3D space.

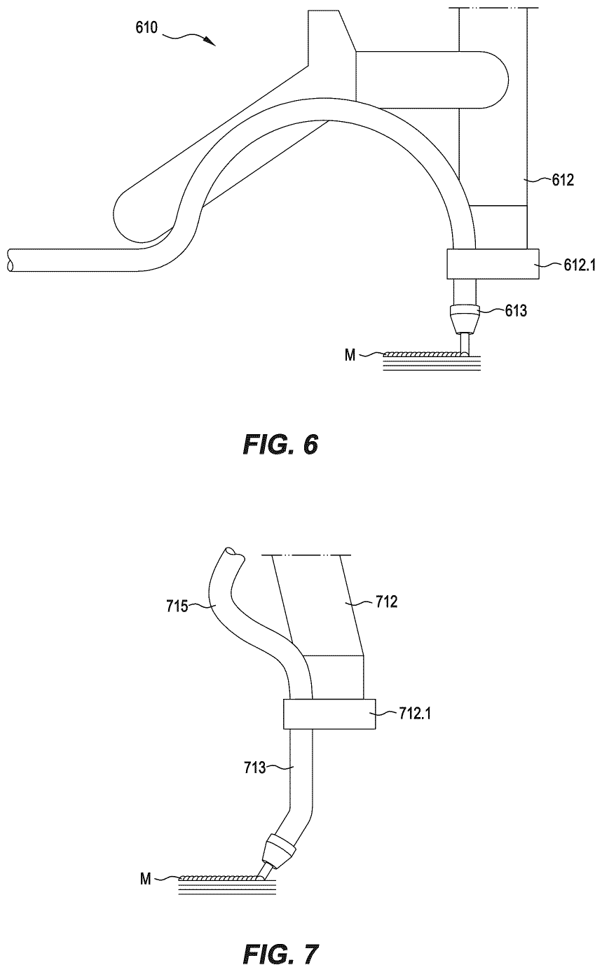

FIG. 6 shows a 3D printing nozzle 613 that can be optionally fitted to the laying gripper of the robot arm 612 of a lay head 610 of a Hadrian X machine, described for example in prior publications including US8166727 WO2009/026641, WO2009/026642, WO2018/009981, WO2018/009986 and WO2019/014701 and US20210379775. This could be used as a low cost demo with existing Hadrian X equipment. Or it could be used to level an uneven slab or footing, either the whole slab, or just where blocks will be laid. Or it could be used to do 3D printing in conjunction with automated block laying, for example allowing the end effector 612.1 of the robot arm 612 to be used to lay blocks and then subsequently grasp a nozzle to allow mortar to be applied to a course of blocks.

FIG. 7 shows a variation of this concept in which a 3D printing and mortar application nozzle 713 is permanently fitted to the laying gripper jaw 712.1 of the robot arm 712 of a Hadrian X block laying machine, with piping 715, such as a rubber hose or articulated steel pipe being used to supply construction material, such as mortar, to the nozzle 713. This can be used to apply mortar for block laying to both the bed (horizontal) and the perp (vertical) joints.

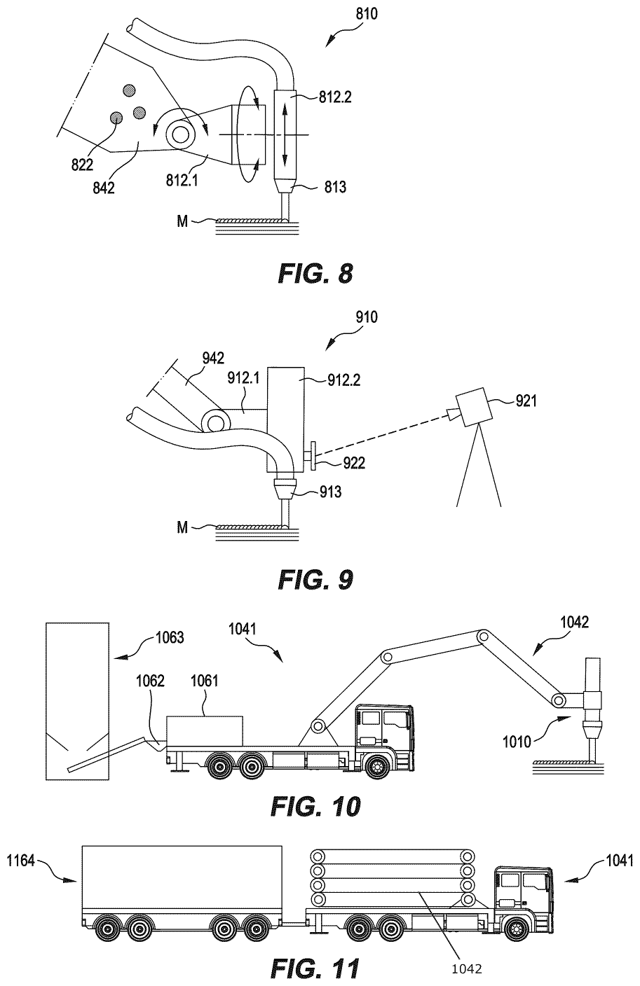

FIG. 8 shows a replacement head 810 that replaces the robot arm of a Hadrian X block laying machine. In this example, the head 810 includes a support 812.1 pivotally mounted to the boom 842 about a horizontal axis, with a linear actuator arm 812.2 rotatably mounted thereto about an orthogonal axis, to thereby provide 3 axes of stabilised motion. This system can utilise a triple tracker tracking arrangement of the type described in US20210379775 the contents of which is incorporated herein by cross reference. Specifically, the triple tracker arrangement includes three tracker targets 822 mounted on the boom 842 of the block laying machine, which can be detected by a laser tracker.

Arrangements of this form include a tracking base provided in an environment, the tracking base including a tracking head support and at least three tracking heads mounted to the tracking head support. Each tracking head includes a radiation source arranged to send a radiation beam to a respective target, a base sensor that senses reflected radiation, at least one tracking head actuator that controls an orientation of the tracking head and at least one tracking head angle sensor that monitors an orientation of the tracking head. The target system includes at least three targets 822 mounted to the boom, each target including a reflector that reflects the radiation beam to the base sensor of a respective tracking head. In this arrangement, the control system causes each tracking head to track a respective target as it moves throughout the environment, determines a position of each target with respect to a respective tracking head at least in part using signals from each base sensor and the at least one tracking head angle sensor. The control system then determines an orientation of the target system using at least in part the determined position of each target and determines the position and orientation of the object using at least in part the position and orientation of the target system.

FIG. 9 shows a similar arrangement to that described above, in which a delivery head 910 includes a support 912.1 pivotally mounted to the boom 942 about a horizontal axis, with a linear actuator arm 912.2 rotatably mounted thereto about an orthogonal axis, to thereby provides 3 axes of stabilised motion. In this example, a simplified single tracker arrangement is used which tracks a retro reflector 922 mounted on the nozzle 913 and or actuator arm 912.2. The retro reflector could rotate around the nozzle to keep line of sight to the tracker.

FIG. 10 shows the layout of a 3D printing machine, including a vehicle 1041 having a concrete pump 1061 and a hopper 1062, a boom 1042 extending from the vehicle, and supporting a delivery head 1010. In use, material is supplied from a silo 1063 or other delivery mechanism into the hopper 1062. Material is provided from the hopper 1062 to the pump 1061, where it is pumped through a delivery pipe forming the boom, to the delivery head 1010. This is similar to a concrete pump boom (e.g. made by Putzmeister or Schwing).

FIG. 11 shows the boom 1042 packed up on the vehicle 1041 and a hopper trailer 1164 containing the 3D printing material.

It will be appreciated that a concrete pump type boom can be used in these configurations, although the boom tip of a traditional concrete pump type boom is not dynamically stable. Adding a delivery head including DST type of stability as described above enables accurate 3D printing. 3D printing materials would have lower flow rates than concrete and probably need a higher pressure (printing materials and mortar have less slump than concrete for pumping), and the boom needs CNC control, thus a standard concrete pump would need to be adapted for the task. Ideally a custom machine would be developed with a lighter boom and smaller pipes (e.g. diameter 40 mm instead of diameter 100 mm).

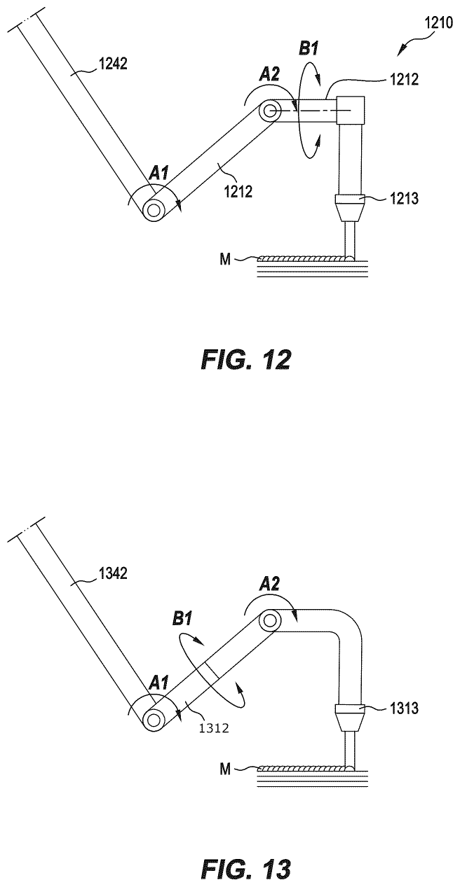

FIG. 12 shows a system including a boom 1242 and delivery head 1210, having two articulated members 1212, such as articulated delivery pipe segments, supporting the nozzle 1213, and having articulation about axes A1, A2 and B1. This arrangement achieves 3 axis motion at the tip of the nozzle with all revolute (articulating) joints (pitch-pitch-roll or PPR joint sequence).

FIG. 13 shows a system including a boom 1342 and delivery head 1310, having a single articulated member 1312, supporting the nozzle 1313, and having articulation about axes A1, A2 and B1. This arrangement achieves 3 axis motion at the tip of the nozzle similar to that shown in FIG. 12, but with a different joint sequence (pitch-roll-pitch or PRP), that achieves the required 3 axis motion at the tip of the nozzle with all revolute (articulating) joints.

The concept of the robots or arrangements in FIGS. 12 and 13 is that the joints (A1, A2, B1) move the articulated members 1212 to move the end of the nozzle 1313. Although the movement will slightly change the orientation of the nozzle, it is insignificant for a 3D printing application for the small DST correction movements needed. Low response rate DST would be applied to the boom, and high response rate DST to the nozzle robot.

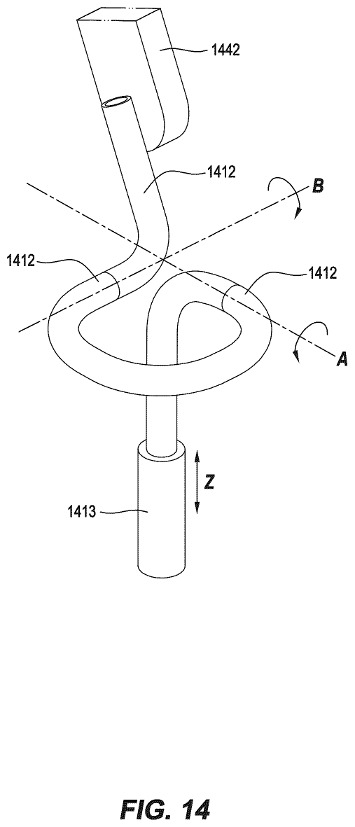

Further embodiments of delivery heads for a concrete pump or large manipulator boom are shown in FIGS. 14 to 22.

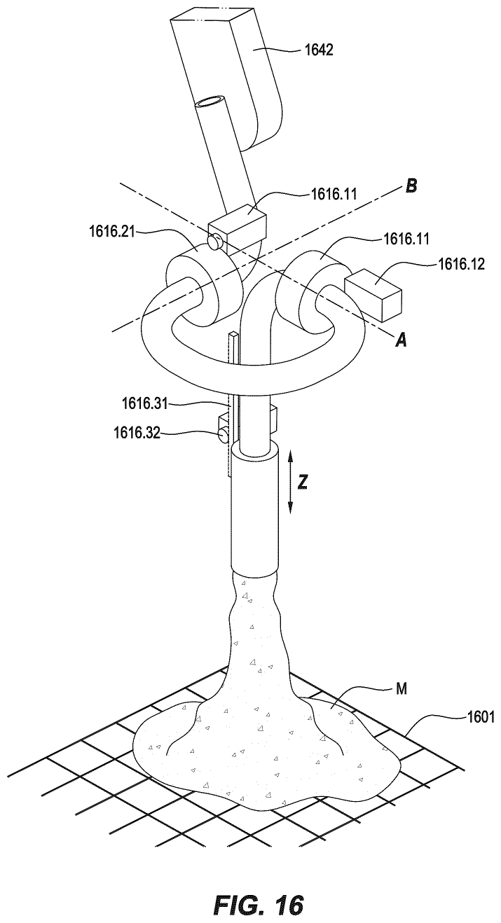

FIG. 14 shows a three axis fine manipulator on the end of a concrete pump boom 1442, which includes three articulated members 1412, such as pipe segments, or arms supporting pipe segments, or a separate flexible pipe. (see also FIG. 16). The manipulator rotates about the A and B axes in a gimbal fashion. The optional Z axis slides telescopically. The A, B and Z axes would be hydraulic servo driven or electric servo driven to stabilise the Tool Centre Point (TCP). Stabilisation could be by inertial measurements to limit acceleration of the TCP. Stabilization could be via three axis measurement of the end of the boom (e.g. by laser tracker, ATS (Automatic Total Station), theodolites, GPS etc). The orientation of the material delivery pipe is not critical, as long as it is approximately vertical and at a reasonable height. In most cases the Z axis would not be required.

In an alternative operating mode, the A and B axes could alternatively not be stabilised and could have separate control to allow fine positioning of the nozzle without having to move the boom 1442. This can be used to replace the existing manual process currently performed by a person handling a hanging hose. Alternatively, the A and B axes could be controlled with a cyclic or repetitive motion so that as for example the boom is moved along a straight path, the A and B axes move the nozzle from side to side to distribute the concrete across a wider area. Or for example if the boom is filling a rectangular column the A and B axes could direct the nozzle toward the rebar and formwork around the edges of the column as the boom moves the nozzle up.

It should be noted that in the above example, the nozzle is shown pointing vertically down. However, the nozzle could be pointed more horizontally and used to spray material, for example shotcrete, allowing construction material to be delivered to a vertical or sloped surface.

By combining TCP control of the boom 1442, with TCP control of the A, B and Z axes, the nozzle 1413 could be programmed to follow a toolpath to automatically place concrete on a slab or into formwork, spray shotcrete or place 3D printing construction material.

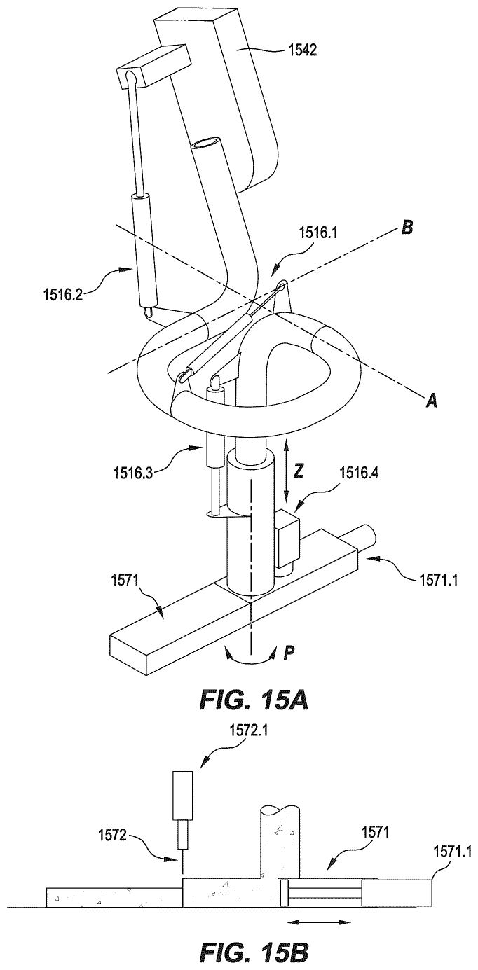

FIG. 15A shows an arrangement incorporating linear actuators 1516.1, 1516.2, 1516.3, such as electronic, pneumatic or hydraulic actuators used to provide articulation around A, B and Z axes. Additionally, the arrangement incorporates a ‘kerbing” type of forming trowel 1571 mounted at the end of the nozzle and configured to slew about an axis P using a rotary actuator 1516.4. This would allow the boom to lay kerbing, or to build walls by stacking layers of kerbing. The kerbing head with an internal reciprocating ram 1571.1 allows concrete to be rammed to fill the trowel form completely and creates a high quality void free product. A guillotine 1572 as shown in FIG. 15B can also be mounted to the nozzle and/or delivery head using a linear actuator 1572.1, which allows the guillotine to be optionally positioned so that a kerb or wall to be started in a specific place by holding the delivery head stationary whilst ramming concrete against it using a biasing mechanism such as the ram 1571.1. It also allows the kerb or wall to be finished in a specific place by cutting the wall or kerb at the finish location and then dragging the excess away.

FIG. 15A also shows how rams (hydraulic or electric) could be used to move the A and B and Z axes. Note that the A and B axes should have a limited range of motion to limit the change in angle of the kerbing head. A and B should move only enough to correct the boom accuracy and lateral bounce.

FIG. 16 shows an arrangement including rotary actuators, such as electronic, pneumatic or hydraulic actuators used to provide articulation around A, B and Z axes. Specifically, in this example ring gear or hollow reducers 1616.11, 1616.21 driven by hydraulic rotary motors or electric servo motors 1616.12, 1616.22 could be used to move the A and B axes and a rack 1616.31 and pinion 1616.32 could move the Z axis. It also shows material M being delivered coincident with rebar 1601.

Note that in the above examples of FIGS. 12 to 16 the delivery head structure is formed by the delivery pipe, with rotational articulation being achieved using rotary joints in the pipe. In this example, the pipe can use the normal kind of rotary seals used on folding concrete pump booms and have additional bearings to support the structure in a rigid way.

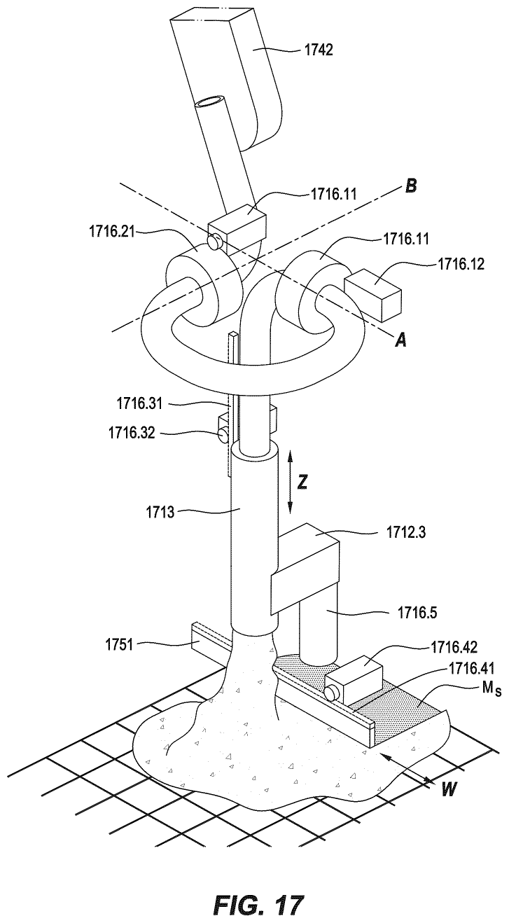

FIG. 17 shows an arrangement similar to that of FIG. 16, albeit with the addition of a screeding member in the form of a screeding bar 1751, mounted to the nozzle 1713 via a bracket 1712.3. The screed bar 1751 can rotate about a substantially vertical axis C using a rotary actuator 1716.5 and slide on a horizontal axis W using a rack 1716.41 and pinion 1716.42. The C and W axes allow the screed bar to work into corners and also to move from side to side or to sweep in an arc pattern to move, distribute and smooth the concrete, to result in smoothed concrete Ms. Additionally, the bracket 1712.3 may be rotatably mounted to the nozzle 1713 so the screeding bar 1751 trails the nozzle.

Note that when screeding it is anticipated that the A and B axes would be used to maintain the C axis vertical. The C and W axes would move the concrete. The boom would be held substantial still or on a slow continuous programmed or commanded trajectory. The C and W axes could be programmed to have a virtual TCP at some point on the screed bar and the motion could be programmed to keep the screed bar TCP on path. For example, an end of the screed bar could be set as the TCP and the boom and screed bar could then be programmed to have the screed bar TCP follow the edge of a slab along the formwork. Note that it would be possible to set up for example a laser or a tight metal wire (string line) to provide a straight line reference and have the screed bar follow the laser line via input sensing from a PSD intercepting the laser line or an electric or magnetic proximity sensor sensing a metal wire.

The boom could be taught the entire motion or the motion boundaries. For example, it could be guided manually around the edges of the slab or guided to the corners of a polygon and then put into an auto mode to automatically fill the polygon or taught shape with concrete and then change to screeding mode to screed, float and smooth the concrete.

The screed bar could be interchangeable (by quick connection) replaced with a “bull float”, a helicopter trowel, or trowels or other tools.

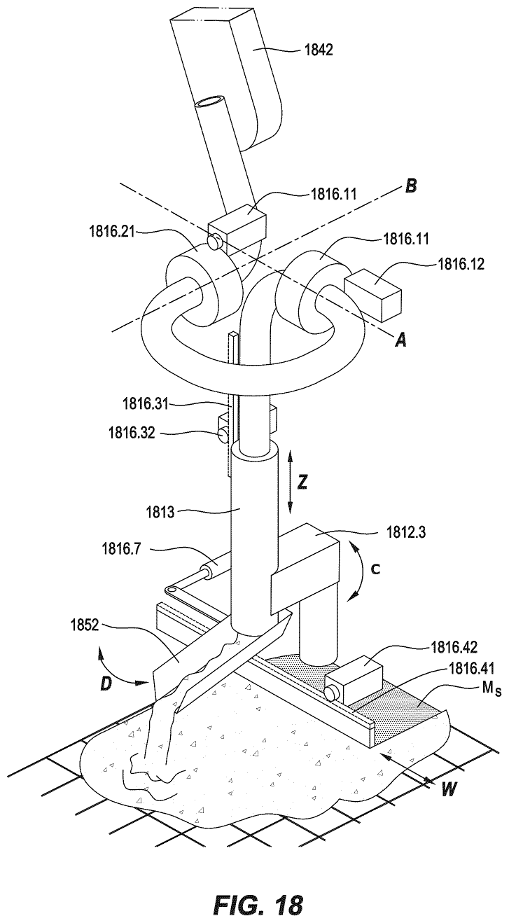

FIG. 18 shows an arrangement similar to that of FIG. 17, albeit with the addition of a chute 1752 attached to an actuator 1716.7 to rotate the chute about an axis D and thereby distribute the concrete. This allows a longer screed bar to be used and the concrete to be placed over a wider area with each “sweep” of the main boom. The chute could be manually controlled, programmed to follow a TCP or programmed to oscillate or rotate. A typical motion would be to program the boom and screed to a TCP trajectory to fill a slab on “diagonal” passes from a corner whilst having the chute oscillate to distribute concrete across about half of the width of the screed bar.

Note that it would be advantageous to have the screed bar move perpendicular to the W axis so that it can directly push concrete. This would allow the screed bar to manipulate the concrete in a desirable pattern such as a figure eight, where it pushes concrete towards previously laid concrete and then screeds away to the new area.

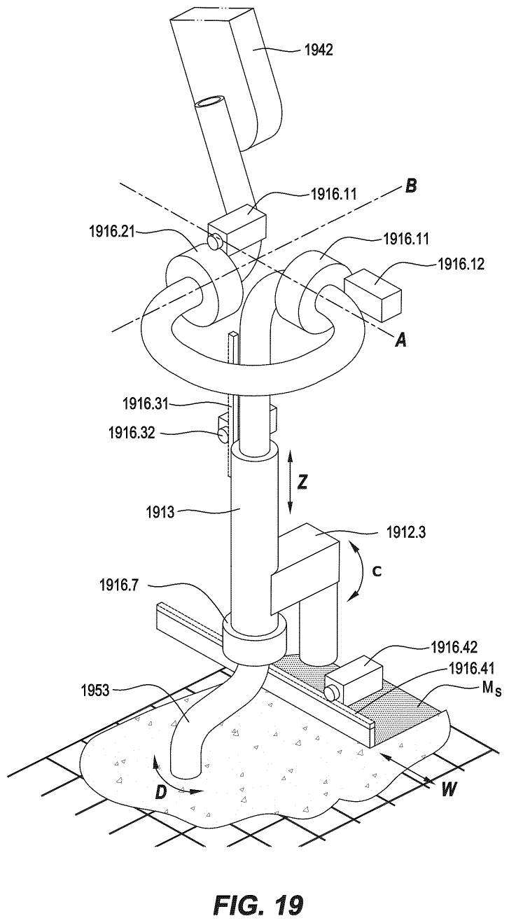

FIG. 19 shows an arrangement similar to that of FIG. 18, albeit with the chute 1852 replaced by a pipe 1953 and driven by a rotary drive or hollow reducer 1916.7.

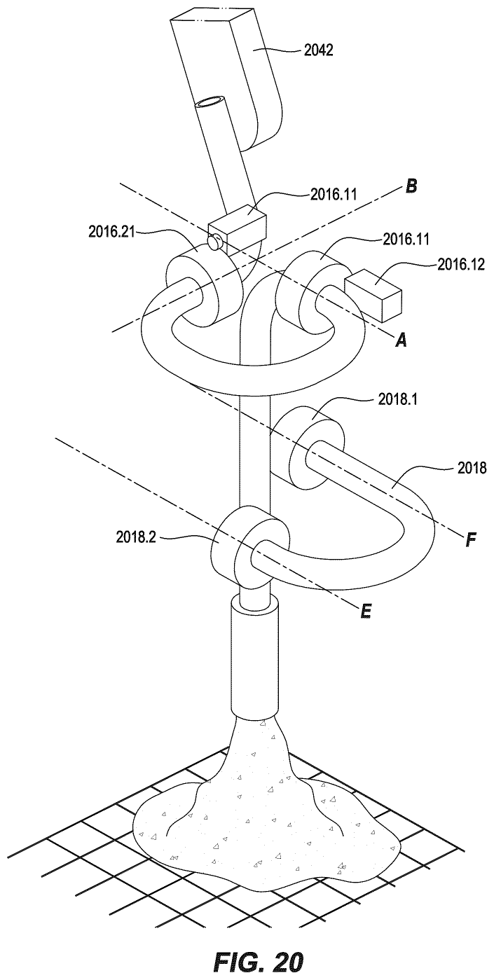

FIG. 20 shows an arrangement similar to that of FIG. 18, albeit with the sliding linear Z axis replaced with a J shaped jointed arm 2018 having rotary actuators 2018.1, 2018.2 at each end to allow for articulation about axes E and F. Changing the angle of E and F effectively changes the distance between the A axis and the nozzle (or TCP).

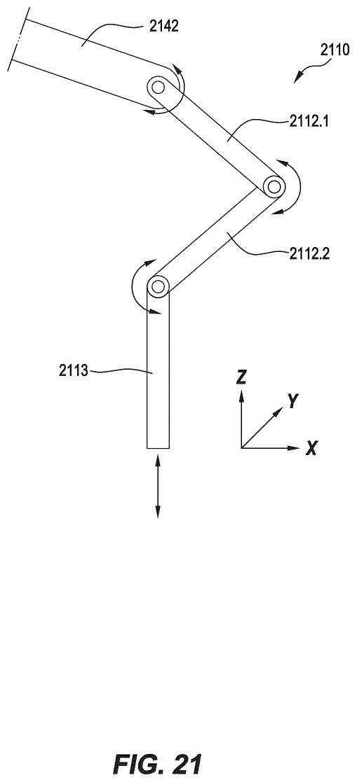

FIG. 21 shows an arrangement of a delivery head that will correct the main motion of the boom 2142, i.e. the up down and “in-out” bounce of the boom and not correct the sideways (boom slew) motion. Articulated members 2112.1, 2112.2, such as articulated pipe members or arms supporting pipe segments or a flexible pipe, and nozzle 2113 are pivoted so that they effectively form a SCARA type robot arrangement that allows vertical and horizontal movement in the vertical plane of the boom. The nozzle end 2113 could be free pivoting and aligned by gravity and could support a hose. This arrangement requires only two additional axes of motion to substantially and effectively provide fine control of the end of the pipe, but of course will not correct motion in slew direction of the boom.

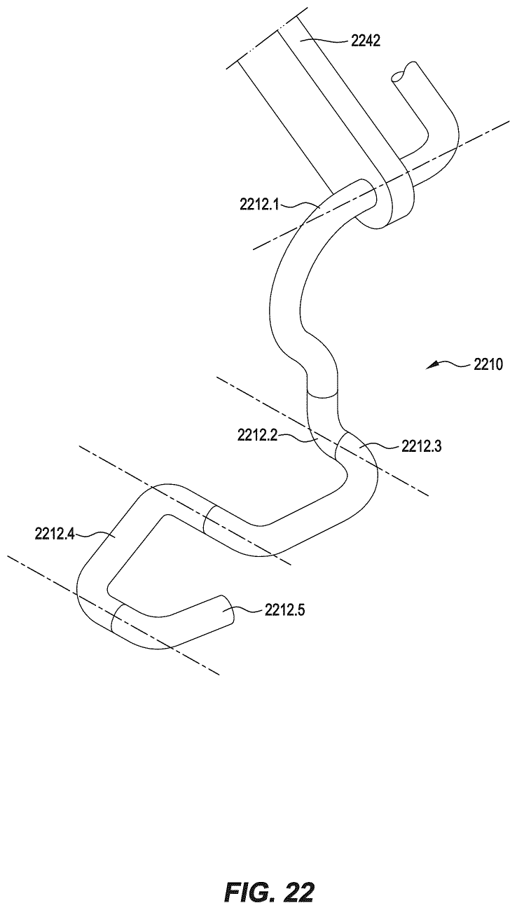

FIG. 22 shows a 5-axis fine manipulator for integration onto the end of a concrete pump boom 2242, including five articulated members 2212.1, 2212.2, 2212.3, 2212.4, 2212.5, the latter of which can incorporate the delivery nozzle. This allows correction and compensation of the position and the orientation of the delivery nozzle. Note that an additional 6th axis (not shown) could be added to orient, for example a trowel or screeding unit. In the arrangement shown, the delivery nozzle is pointing substantially horizontal in a shotcrete spraying attitude. For example, the unit could spray shotcrete onto a wall or the formwork or rebar of a wall and then screed and trowel it on a wall or a 3D formed shell such as a dome. This would also allow large scale and free form 3D printing. In another arrangement, the delivery nozzle may be oriented with a vertical attitude, a typical orientation for pouring a slab. It shall be appreciated that the other items described earlier (chute, pipe, screed bar etc) could be added to this arrangement.

A further aspect of the disclosure relates to pumps for pumping concrete.

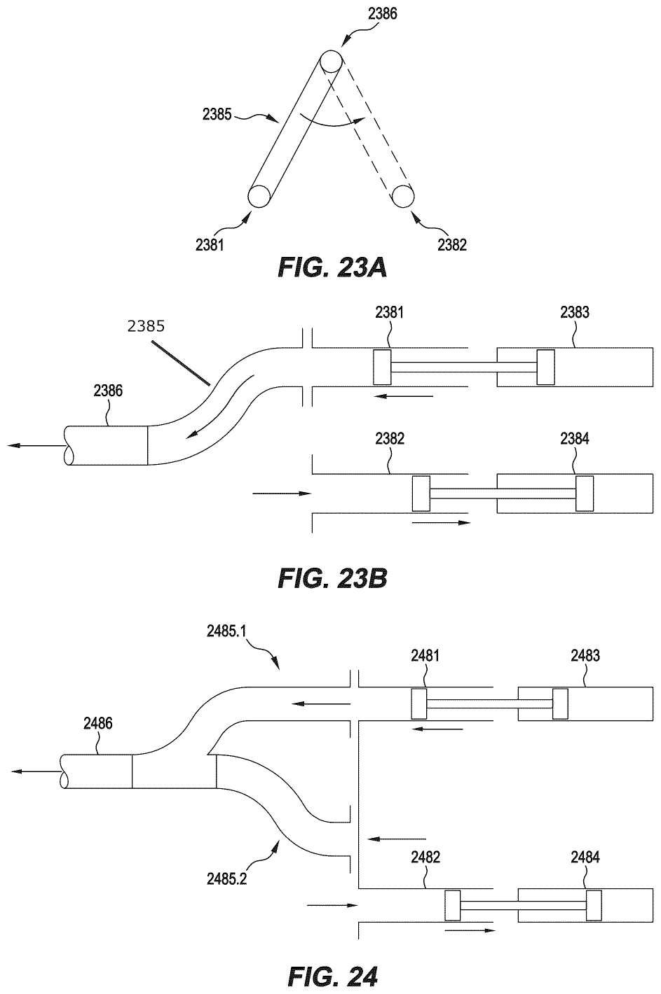

It is known to use a two-piston pump for pumping concrete and an example will now be described with reference to FIGS. 23A and 23B. Typically, such pumps have hydraulic rams 2383, 2384 pushing respective pistons in cylinders 2381, 2382, which are selectively connected to a delivery pipe 2386 via a swing valve 2385. Concrete goes into a pump cylinder and is forced out by the pump piston which is pushed by the hydraulic ram 2383, 2384, with swing pipe valve 2385 shifting from one cylinder to the other so concrete is pumped from one cylinder while the other is filled with concrete. In this manner, the pistons 2381, 2382 alternately pump and fill with concrete.

The intermittent nature of the flow creates large changing forces in the delivery pipe and intermittent flow of concrete, which results in the boom bouncing. The bounce creates fatigue in the boom structure, dynamic pressure fluctuations fatigue the pipe and the bouncing boom makes inconsistent concrete delivery. The varying flow rate makes concrete delivery to a pre-planned path difficult, if not impossible. The varying flow rate makes it difficult to deliver concrete evenly to a slab and a lot of manual moving of concrete (by rakes, screeds, shovels etc) is required to get the concrete to the right position.

An improved pump arrangement as shown in FIG. 24 aims to achieve uniform and continuous and variable concrete flow and delivery. It replaces a single swing pipe valve with two swing pipe valves 2485.1, 2485.2, one for each pump cylinder 2481, 2482. The pump pistons are controlled by servo hydraulic cylinders or hydraulic rams 2483, 2484, such that the total flow remains constant. To achieve this, the pump cylinder being filled is filled faster than the delivery cylinder is delivering. Toward the end of the piston stroke of the first cylinder 2481, the second swing valve 2485.2 is moved into a delivery position and the piston stroke of the second cylinder 2482 is started so that as the first piston slows, the second piston speeds up exactly to maintain constant flow. Near the end of the second piston travel the first piston travel is sped up. Preferably the position of the hydraulic piston is measured by a linear encoder, such as a temposonics cylinder rod encoder or by an encoder integrated into the rod of the cylinder (e.g. Parker magnetic rod encoder). Preferably the position of the cylinder and the pressure of the delivered concrete and a desired flow rate is used in a feedback loop to control the hydraulic cylinder speed and position.

Two, three or more pump cylinders and swing valves can be used to accommodate various materials. For example if a material does not fill the pump cylinder fast enough, more pump cylinders can be used.

The pump has application for delivering 3D printing material where high-pressure continuous flow is desirable.

The pump has application where the concrete pump boom delivery is controlled along a TCP to uniformly deliver concrete to a slab or mould or formwork.

The pump has application to deliver 3D printing materials over a long distance.

Piston pumps have longer life and can achieve higher pressure than peristaltic pumps or progressive cavity pumps and have better wear resistance than gear pumps.

Examples of working machines for working construction material will now be described.

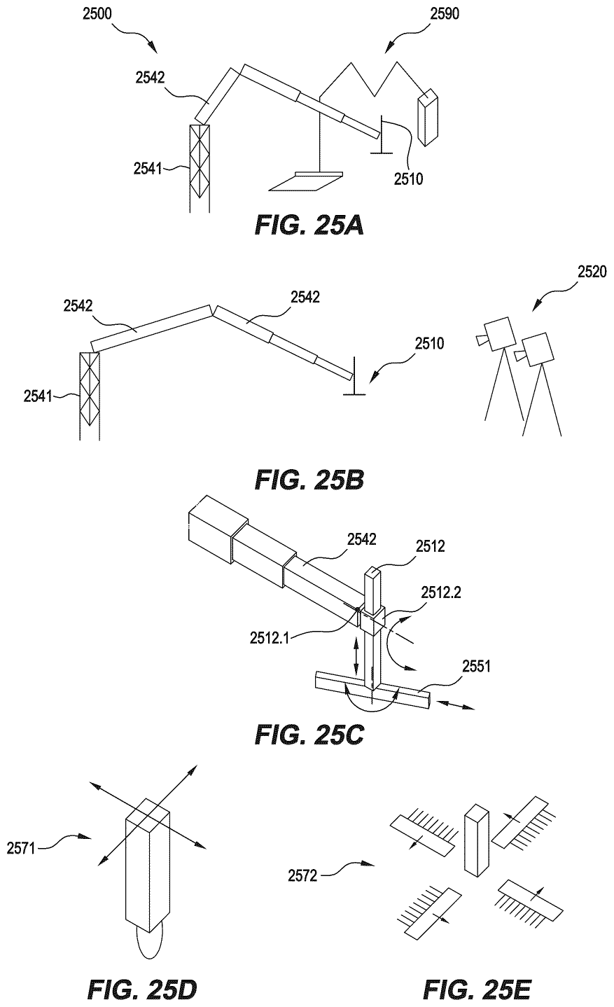

Referring now to FIGS. 25A to 25E, a DST assisted concrete screed and helicopter trowel machine that can work together with a concrete boom pump are shown.

In this example, a concrete delivery machine 2590 is provided, which can be similar to those described above, or could be an existing concrete delivery system, including a vehicle mounted or tower crane column high-rise concrete boom pump, depending on the application.

In this example, the working machine 2500 includes a base 2541, which could be a vehicle or high-rise tower crane column, having a boom 2542 extending therefrom. The boom 2542 includes an articulated working head 2510 of a form similar to the delivery heads described above. The working machine is used in conjunction with a tracking system 2520, similar to those described above, which can be used to track movement of the boom, working head or a working member attached to the working head.

As shown in FIG. 25C, in one example the working head includes a screeding bar 2551 mounted on an articulated member 2512, which includes a linear actuator 2512.2 to allow the working member to be raised and lowered. The articulated member 2512 is attached to the boom via a rotational joint 2512.1, allowing an orientation of the articulated member 2512, and hence the screeding bar 2551, to be altered.

This arrangement is primarily for concrete screeding, however the toolhead could swap between screed and helicopter type trowel (or a lighter trowel) 2572, shown in FIG. 25E, or a rebar tie head 2571, shown in FIG. 25D. Other suitable working members could include a concrete grinding and polishing head, a paint, pressure wash or sand blast head. The screed can act as a “rough rake” to spread concrete and then screed.

The working head doesn't necessarily need all 6 DOF corrected with DST, although this is not excluded, and may be used in some situations, depending on the nature of the working being performed. A semi auto type of operation would work very well where the XY planar position of the boom 2542 is controlled by the operator with a joystick (the control system would do a kinematic transform and work out the required boom slew, lift, luff and extension angles) and the angle of the screed is controlled with a joystick or lever. The roll, pitch and Z axis movement of the screed working member (and the Z axis of the boom) would be automatically controlled by DST. The operator would have a manual control to be able to lift the working member in the Z axis direction for retraction or to deal with big piles of concrete but there would be a “virtual floor level” that the operator couldn't go below (without some kind of override button being pushed). For trowelling where multiple passes are needed there could be a “teach mode” where the boom learns the movements and then the operator can replay them with say the left joystick controlling the “feed speed” of the boom and the right joystick controlling the rotation speed of the trowel (trowelling speed needs to change as concrete cures).

The boom can be very lightweight and simple construction similar to a Hiab crane, and could be manufactured from steel sections. The boom could be mounted onto a concrete pump truck as an independent second boom, or could be retro fitted to existing truck type booms like Hiab, Effer. The boom could be mounted on a tower crane column to work with a high-rise concrete boom pump.

It is possible to add additional telescopic stages to meet any extension requirement. Typical concrete pump booms are from 20 m to 60 m reach. For example, a 32 m reach boom could be used as mid range option with much more utility than the 5m reach “auto screeds” (Lichine Screed saver Boss or Dragon Screed).

It will be appreciated that the articulated telescopic boom arrangement can be used in collaboration with a concrete pump boom. The working head could also be added as an attachment to the boom of an excavator.

A lidar sensor(s) at the screed head could be used to provide safe presence sensing. The Lidar would act just above the screed height.

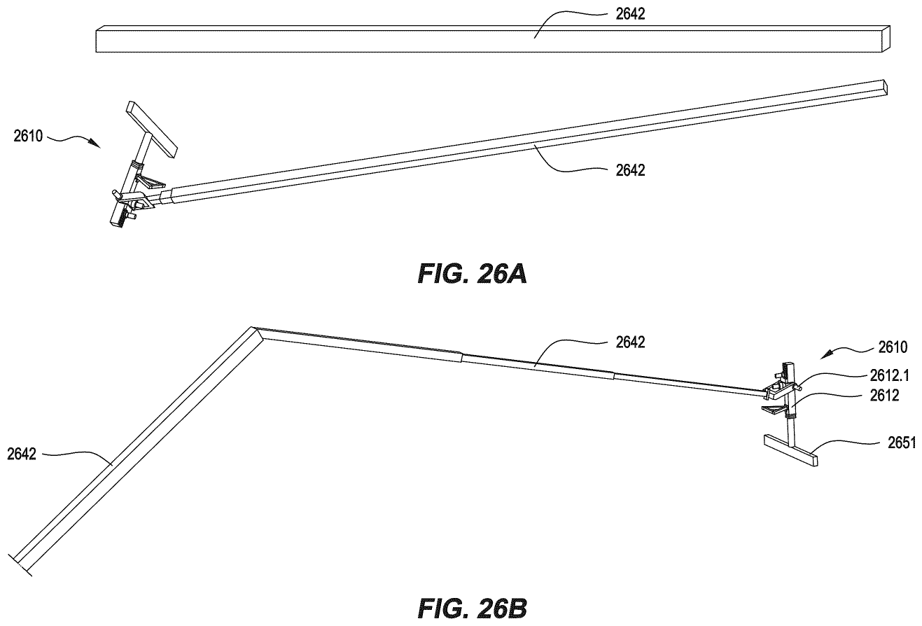

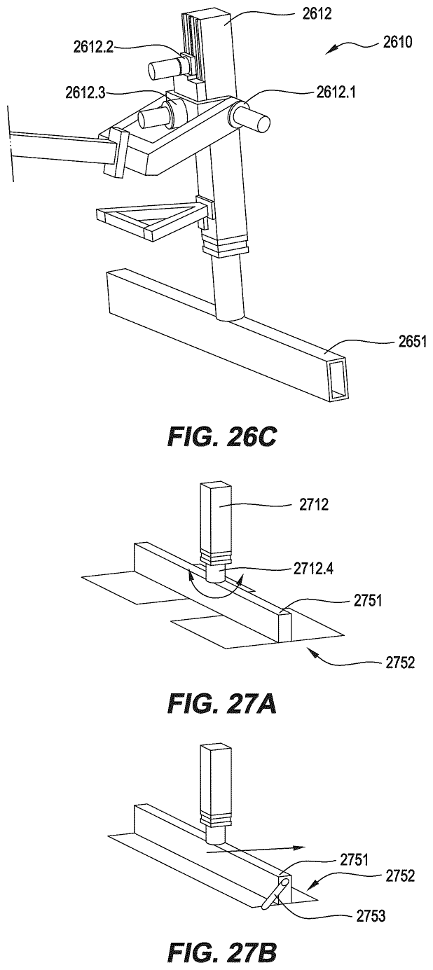

Further illustrations of a DST enabled screeding head attached to the end of long boom are shown in FIGS. 26A to 26C.

In this example, the working head 2610 is attached to a boom 2642, shown in folded and extended positions in FIGS. 26A and 26B respectively. In this example, the screeding bar 2651 is attached to the articulated member 2612, which includes a linear actuator 2612.2, and is connected to the boom via rotational joints 2612.1, 2612.3 to allow movement with three degrees of freedom.

As an alternative to an interchangeable head to allow use of a screed or helicopter trowels, a screed bar may be provided including attachable or deployable trowels, and example of this will now be described with respect to FIGS. 27A and 27B.

In the example of FIG. 27A, the screed bar 2751 is rotatably mounted to the articulated member 2712 using a rotational servo motor 2712.4, allowing the screed bar to be rotated. Trowel elements are provided which can be attached to the screed bar so that this acts as a helicopter trowel when rotated. In the example of FIG. 27B, the trowel elements are hingably mounted to the screed bar 2751 so these can be folded into position and held in place using link bars 2753.

This avoids having to hook up power via a removable connection for a separate helicopter trowel.

Normally helicopter trowels have 4 trowels so they are self-stable. The head is stabilised so two trowels or even one is fine. Having only one trowel fitted makes it possible to trowel into corners, or trowel a specific pattern, for example for surface effects.

It is also possible to fit a texturing brush, broom or roller (for surface texture) or grooved trowel to trowel expansion joints.

It is possible to fit a powder dispensing unit to distribute cement powder, hardening agent, pigments, acid, paint, liquid films (e.g. moisture evaporation inhibitors, accelerators, membranes etc). It is also possible to fit a roll dispenser for e.g. plastic film for rain protection, under slab plastic i.e. use it before the concrete is applied to roll out the plastic), pond or dam lining plastic, or concrete surface texture templates (e.g. “crazy paving” or “block paving” template).

Of course, it is desirable to be able to fit other attachments as well such as grinding heads, drills etc.

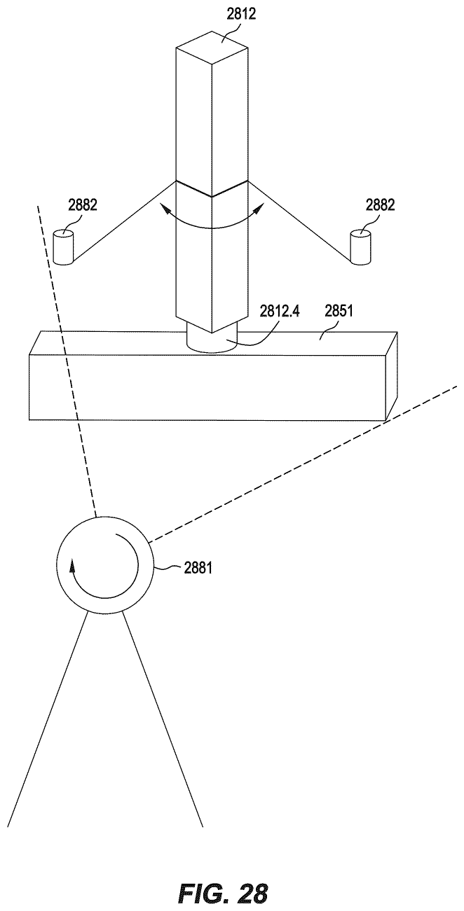

In regard to position measurement of the head, to reduce laser tracker cost it is possible to use a standard rotating laser level and machine position sensitive detectors (PSDs) as shown in FIG. 28.

In this example the screed bar 2851 is rotatably mounted to the articulated member 2812 using a rotational servo motor 2812.4, allowing the screed bar to be rotated. Three PSDs 2882 are arranged to measure three points on a plane. To maintain line of sight as the boom slews over the building site, the three PSDs are mounted on a frame that slews about the Z axis. The PSDs only get a signal at the rotation frequency of the rotating laser 2881 which is not fast enough for dynamic compensation, therefore a Z axis accelerometer is added, optionally with a Z axis accelerometer at each PSD location. The XY position of the screed is not critical as its task is to establish a planar slab.

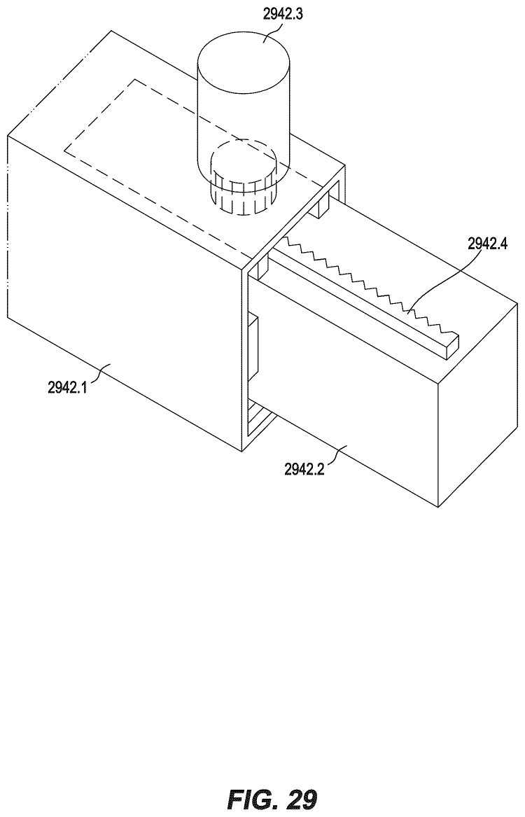

The stick extension is long and a long enough hydraulic ram would be heavy. It would require either a chain/pully or rope system to “gear up the movement”. It may be easier and better to servo drive it via a rack. Putting the rack on the top of the stick means the structural support of the stick is good with telescoping sidewalls with low clearance and a continuous support on the bottom of the inner stick. An example stick extension arrangement is shown in FIG. 29 using Ultra High Mechanical Polyethylene (UHMPE).

In this example, the boom elements 2942.1, 2942.2 are telescopic with the internal element 2942.2 having rack 2942.4 mounted thereon, whilst the outer boom element 2942.1 includes a drive motor 2942.3 which drives a pinion that engages the rack to thereby retract and extend the boom element 2942.2.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciate that numerous variations and modifications will become apparent. All such variations and modifications which become apparent to persons skilled in the art, should be considered to fall within the spirit and scope that the invention broadly appearing before described.

1. A robotic construction system for use in constructing a structure, the construction system including:
a) a base;
b) a boom extending from the base;
c) an articulated delivery head attached proximate an end of the boom, the delivery head including a nozzle configured to deliver a construction material; and,
d) a controller configured to control movement of the boom and the delivery head to thereby move the nozzle and deliver construction material, wherein the boom moves with a slower dynamic response over larger distances and the delivery head provides a faster dynamic response over smaller distances.

2. The system according to claim 1, wherein the controller is configured to control the delivery head to dynamically stabilise the nozzle and thereby correct for unintentional movement of the end of the boom.

3. The system according to claim 1 or claim 2, wherein the controller is configured to control the boom and the delivery head to control movement of the nozzle during delivery of construction material.

4. The system according to any one of the claims 1 to 3, wherein the controller is configured to control the boom and the delivery head to deliver construction material along a desired delivery path.

5. The system according to claim 4, wherein, while construction material is being delivered, the controller is configured to:
a) control the boom so as to move the end of the boom to thereby provide coarsely guided movement of the nozzle relative to the delivery path; and,
b) control the delivery head to move the nozzle to thereby provide fine positioning of the nozzle as the nozzle moves relative to the path.

6. The system according to claim 4 or claim 5, wherein the controller is configured to control the boom and delivery head to move the nozzle relative to at least part of the delivery path as construction material is delivered substantially continuously.

7. The system according to any one of the claims 1 to 6, wherein the delivery head is articulated on two axes to move the nozzle with two degrees of freedom to thereby allow for movement of the nozzle in two orthogonal spatial directions.

8. The system according to claim 7, wherein the two orthogonal spatial directions are one of:
a) horizontal spatial directions to correct for longitudinal and lateral movement of the end of the boom;
b) one horizontal and one vertical direction to correct for longitudinal and vertical movement of the end of the boom; and,
c) one horizontal and one vertical direction to correct for lateral and vertical movement of the end of the boom.

9. The system according to any one of the claims 1 to 8, wherein the delivery head is articulated on three axes to move the nozzle with three degrees of freedom to thereby allow for movement of the nozzle in orthogonal spatial directions.

10. The system according to claim 9, wherein movement of the nozzle in orthogonal spatial directions is used to correct for longitudinal, lateral and vertical movement of the end of the boom.

11. The system according to any one of the claims 1 to 10, wherein the delivery head is articulated with axes to provide one of:
a) pitch, roll, pitch movement;
b) pitch, pitch, roll movement; and
c) pitch, roll and sliding movement.

12. The system according to any one of the claims 7 to 11, wherein the delivery head is further articulated on a further axis to adjust a pitch of the nozzle.

13. The system according to claim 12, wherein the delivery head is articulated on another further axis to adjust an orientation of the nozzle.

14. The system according to any one of the claims 1 to 13, wherein the delivery head is articulated using at least one of:
a) a rotational actuator;
b) a linear actuator;
c) a hydraulic motor;
d) an electric motor;
e) a hydraulic ram;
f) an electric ram;
g) a hydraulic servo; and,
h) an electric servo.

15. The system according to any one of the claims 1 to 14, wherein one of:
a) the nozzle is arranged substantially vertically to deliver construction material downwardly onto a surface; and,
b) the nozzle is arranged substantially horizontally to deliver construction material laterally onto a surface.

16. The system according to any one of the claims 1 to 15, wherein the delivery head includes a robot arm and end effector, and wherein the nozzle is supported by the end effector.

17. The system according to any one of the claims 1 to 16, wherein the delivery head includes a working member to work the delivered construction material.

18. The system according to claim 17, wherein the working member includes one of:
a) a screed member;
b) a trowel;
c) formwork;
d) a mould; and,
e) a biasing member configured to urge working material;
f) a cutting implement;
g) a grinding head;
h) a polishing head;
i) washer head;
j) a sand blast head; and,
k) a guillotine.

19. The system according to claim 17 or claim 18, wherein the delivery head is articulated to at least one of:
a) independently move the working member and the nozzle;
b) move the working member relative to the nozzle;
c) allow for rotation of the working member around the nozzle;
d) control a height of the working member relative to the nozzle; and,
e) control an orientation of the working member.

20. The system according to any one of the claims 17 to 19, wherein the delivery head is articulated about three axes to allow the working member to be maintained in a fixed orientation with a further articulation being provided to allow height and/or positional adjustment of the working member.

21. The system according to any one of the claims 17 to 20, wherein the delivery head is articulated to allow rotation and horizontal movement of the working member.

22. The system according to any one of the claims 1 to 21, wherein the system includes a boom actuator configured to move the boom.

23. The system according to claim 22, wherein the boom actuator is configured to at least one of:
a) slew the boom;
b) extend or retract the boom;
c) unfold the boom; and,
d) raise or lower the boom.

24. The system according to any one of the claims 1 to 23, wherein the system includes a tracking system configured to measure a position and/or movement of at least one of:
a) the delivery head;
b) the end of the boom;
c) the boom; and,
d) the nozzle; and
wherein the controller is configured to control the delivery head in accordance with signals from the tracking system.

25. The system according to claim 24, wherein the tracking system includes at least one of:
a) a laser guide;
b) a physical guide and corresponding guide sensor;
c) a positioning sensor;
d) a GPS sensor;
e) a movement sensor;
f) an inertial measurement unit;
g) a machine vision system;
h) a laser tracker;
i) a LiDAR;
j) a radar; and,
k) a ranging sensor; and,
l) an ultrasonic ranging sensor.

26. The system according to claim 24 or claim 25, wherein the tracking system includes:
a) three retroreflectors mounted proximate an end of the boom; and,
b) corresponding laser trackers, wherein the tracking system is configured to measure a position and orientation of the end of the boom based on radiation reflected from the retroreflectors.

27. The system according to claim 24 or claim 25, wherein the tracking system includes:
a) a retroreflector movably mounted on the articulated head proximate the nozzle; and,
b) a laser tracker, wherein the tracking system is configured to measure a position and orientation of the nozzle based on radiation reflected from the retroreflector.

28. The system according to claim 24 or claim 25, wherein the tracking system includes:
a) a laser guide positioned in the environment; and,
b) a sensor mounted on at least one of the boom and the delivery head, the sensor being configured to detect deviation from the laser guide.

29. The system according to claim 28, wherein the laser guide defines at least one of:
a) a height plane; and,
b) a delivery path.

30. The system according to any one of the claims 1 to 29, wherein the system includes a delivery pipe configured to transport the construction material from the base, along the boom, to the nozzle.

31. The system according to claim 30, wherein the delivery pipe includes an articulated steel pipe.

32. The system according to claim 30 or claim 31, wherein the at least one of the delivery pipe and the boom are formed through articulation of the delivery pipe.

33. The system according to any one of the claims 30 to 32, wherein the system includes a hopper configured to receive construction material and a pump configured to pump construction material from the hopper through the pipe.

34. The system according to claim 33, wherein the pump includes:
a) two pumping cylinders;
b) an associated swing valve for each cylinder, the position of the swing valve adjusting whether the cylinders are filling or dispensing material; and,
c) a controller configured to deliver construction material by:
i) partially emptying one cylinder while the other cylinder is filling; and,
ii) transitioning delivery from one cylinder to the other by reducing a delivery rate from one cylinder while increasing a delivery rate from the other cylinder to maintain an overall delivery rate.

35. The system according to claim 34, wherein the pump includes:
a) a first cylinder containing a first piston driven by a first actuator, the first cylinder being configured to fill with construction material when the first piston is retracted from the first cylinder and deliver construction material when the first piston is extended into the first cylinder;
b) a second cylinder containing a second piston driven by a second actuator, the second cylinder being configured to fill with construction material when the second piston is retracted from the second cylinder and deliver construction material when the second piston is extended into the second cylinder;
c) a first swing valve configured so that in a delivery position the first swing valve connects the first cylinder to the delivery pipe and in a filling position allows construction material to enter the first cylinder;
d) a second swing valve configured so that in a delivery position the second swing valve connects the second cylinder to the delivery pipe and in a filling position allows construction material to enter the second cylinder;
e) a pump controller configured to control the first and second actuators and the first and second swing valves so as to:
i) deliver construction material by partially emptying one cylinder while the other cylinder is filling; and,
ii) transition delivery from one cylinder to the other by reducing a delivery rate from one cylinder while increasing a delivery rate from the other cylinder to maintain an overall delivery rate.

36. The system according to claim 35, wherein the pump controller is configured to:
a) in an initial step:
i) position the first swing valve in the filling position and retract the first piston to fill the first cylinder;
ii) position the first swing valve in the delivery position and commence extending the first piston to start delivering construction material from the first cylinder;
b) in a first step:
i) continue extending the first piston to thereby continue delivering construction material from the first cylinder;
ii) position the second swing valve in the filling position and retract the second piston to thereby fill the second cylinder;
c) in a second step, once the second cylinder is filled with construction material:
i) extend the first piston at a reducing rate to thereby deliver remaining construction material from the first cylinder;
ii) position the second swing valve in the delivery position and commence extending the second piston at an increasing rate to commence delivering construction material from the second cylinder;
d) in a third step, once the first cylinder is empty:
i) position the first swing valve in the filling position and retract the first piston to thereby fill the second cylinder;
ii) continue extending the second piston to thereby continue delivering construction material from the second cylinder;
e) in a fourth step, once the first cylinder is filled with construction material:
i) position the first swing valve in the delivery position and commence extending the first piston at an increasing rate to commence delivering construction material from the first cylinder;
ii) extend the second piston at a reducing rate to thereby deliver remaining construction material from the second cylinder;
f) repeat the first to fourth steps as needed.

37. The system according to any one of the claims 1 to 36, wherein the construction material is at least one of:
a) a viscous fluid;
b) cement based materials;
c) concrete;
d) cement;
e) mortar;
f) shotcrete;
g) a 3D printing material; and,
h) a polymeric material.

38. The system according to any one of the claims 1 to 37, wherein the base is part of a vehicle.

39. A construction material pump including:
a) two pumping cylinders;
b) an associated swing valve for each cylinder, the position of the swing valve adjusting whether the cylinders are filling or dispensing material; and,
c) a controller configured to deliver construction material by:
i) partially emptying one cylinder while the other cylinder is filling; and,
ii) transitioning delivery from one cylinder to the other by reducing a delivery rate from one cylinder while increasing a delivery rate from the other cylinder to maintain an overall delivery rate.

40. The pump according to claim 39, wherein the pump includes:
a) a first cylinder containing a first piston driven by a first actuator, the first cylinder being configured to fill with construction material when the first piston is retracted from the first cylinder and deliver construction material when the first piston is extended into the first cylinder;
b) a second cylinder containing a second piston driven by a second actuator, the second cylinder being configured to fill with construction material when the second piston is retracted from the second cylinder and deliver construction material when the second piston is extended into the second cylinder;
c) a first swing valve configured so that in a delivery position the first swing valve connects the first cylinder to the delivery pipe and in a filling position allows construction material to enter the first cylinder;
d) a second swing valve configured so that in a delivery position the second swing valve connects the second cylinder to the delivery pipe and in a filling position allows construction material to enter the second cylinder;
e) a pump controller configured to control the first and second actuators and the first and second swing valves so as to:
i) deliver construction material by partially emptying one cylinder while the other cylinder is filling; and,
ii) transition delivery from one cylinder to the other by reducing a delivery rate from one cylinder while increasing a delivery rate from the other cylinder to maintain an overall delivery rate.

41. The pump according to claim 40, wherein the pump controller is configured to:
a) in an initial step:
i) position the first swing valve in the filling position and retract the first piston to fill the first cylinder;
ii) position the first swing valve in the delivery position and commence extending the first piston to start delivering construction material from the first cylinder;
b) in a first step:
i) continue extending the first piston to thereby continue delivering construction material from the first cylinder;
ii) position the second swing valve in the filling position and retract the second piston to thereby fill the second cylinder;
c) in a second step, once the second cylinder is filled with construction material:
i) extend the first piston at a reducing rate to thereby deliver remaining construction material from the first cylinder;
ii) position the second swing valve in the delivery position and commence extending the second piston at an increasing rate to commence delivering construction material from the second cylinder;
d) in a third step, once the first cylinder is empty:
i) position the first swing valve in the filling position and retract the first piston to thereby fill the second cylinder;
ii) continue extending the second piston to thereby continue delivering construction material from the second cylinder;
e) in a fourth step, once the first cylinder is filled with construction material:
i) position the first swing valve in the delivery position and commence extending the first piston at an increasing rate to commence delivering construction material from the first cylinder;
ii) extend the second piston at a reducing rate to thereby deliver remaining construction material from the second cylinder;
f) repeat the first to fourth steps as needed.

42. The pump according to claim 40 or claim 41, wherein the pump includes:
a) a first sensor configured to measure a position of the first piston; and,
b) a second sensor configured to measure a position of the second piston, and wherein the controller is configured to control the first and second actuators in accordance with signals from the first and second sensors.
